(19) United States
(12) Patent Application Publication
(10) Pub. No.: US 2024/0031938 A1
(43) Pub. Date: Jan. 25, 2024

(54) POWER CONTROL FOR INTER-LAYER PRIORITY UPLINK CONTROL INFORMATION MULTIPLEXING

(71) Applicant: Apple Inc., Cupertino, CA (US)

(72) Inventors: Weidong Yang, San Diego, CA (US); Yushu Zhang, Beijing (CN); Chunxuan Ye, San Diego, CA (US); Dawei Zhang, Saratoga, CA (US); Haitong Sun, Cupertino, CA (US); Hong He, San Jose, CA (US); Huaning Niu, San Jose, CA (US); Oghenekome Oteri, San Diego, CA (US); Seyed Ali Akbar Fakoorian, San Diego, CA (US); Sigen Ye, Whitehouse Station, NJ (US); Wei Zeng, Saratoga, CA (US)

(73) Assignee: Apple Inc., Cupertino, CA (US)

(21) Appl. No.: 17/442,089

(22) PCT Filed: Aug. 5, 2021
(86) PCT No.: PCT/CN2021/111000

§ 371 Date: Sep. 22, 2021

(51) Int. Cl. H04W 52/14; H04W 52/32

(52) U.S. Cl. CPC H04W 52/146; H04W 52/325

(57) ABSTRACT

The present application relates to devices and components including apparatus, systems, and methods to determine physical uplink control channel transmission power for a multiplexed uplink control information.

### BACKGROUND

Third Generation Partnership Project (3GPP) networks rely on communication between multiple base stations and user equipments. The elements rely on communication and feedback to perform proper operation. As the technology has advanced, the operation of the signals exchanged between the base stations and user equipments has changed. Some of these changes, such as multiplexing of signals, present additional possibilities and challenges.

### BRIEF DESCRIPTION OF THE DRAWINGS

FIG. 1 illustrates an example network arrangement in accordance with some embodiments.

FIG. 2 illustrates an example signal chart in accordance with some embodiments.

FIG. 3 illustrates example uplink control information (UCI) parts in accordance with some embodiments.

FIG. 4 illustrates another example UCI parts in accordance with some embodiments.

FIG. 5 illustrates example an orthogonal frequency division multiplexing symbol diagram in physical uplink control channel (PUCCH) in accordance with some embodiments.

FIG. 6 illustrates an example procedure for determining a PUCCH transmission power for a multiplexed UCI in accordance with some embodiments.

FIG. 7 illustrates example tables for determining the equation to be utilized when using the coding schemes for the first UCI part and the second UCI part as criterion in accordance with some embodiments.

FIG. 8 illustrates an example table that illustrates UCI mappings for separate encoding in accordance with some embodiments.

FIG. 9 illustrates an example table that illustrates additional UCI mappings for separate encoding in accordance with some embodiments.

FIG. 10 illustrates an example procedure for transmitting a multiplexed UCI in accordance with some embodiments.

FIG. 11 illustrates an example procedure for providing transmission information for a multiplexed UCI in accordance with some embodiments.

FIG. 12 illustrates an example user equipment (UE) in accordance with some embodiments.

FIG. 13 illustrates an example next generation nodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

In third generation partnership project release 16 (Rel-16), only uplink control informations (UCIs) of the same layer 1 (L1) priority can be multiplexed in a physical uplink control channel (PUCCH). The power control rules for PUCCH formats are captured in 3rd Generation Partnership Project (3GPP) technical specification (TS) 38.213 (3GPP Organizational Partners. (2021-06). 3rd Generation Partnership Project; Technical Specification Group Radio Access Network; NR; Physical layer procedures for control (Release 16) (3GPP TS 38.213 V16.6.0)). For PUCCH format 0 (PF0)/PUCCH format 1 (PF1), the payload size is not considered in the power control formula. For PUCCH format 2 (PF2)/PUCCH format 3 (PF3)/PUCCH format 4 (PF4), the payload size is considered. Updates to support power control for UCIs at two L1 priorities are presented herein.

In release 17 (Rel-17), it is proposed that for PUCCH resource set selection the payload for high priority (HP) & low priority (LP) UCIs are converted into equivalent HP payload size through:

$$( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ,$$

where the UCIs for HP and LP are enumerated in UCI part I (which may be referred to as a “first UCI part”) and UCI Part II (which may be referred to as a “second UCI part”), N_{UCI-part1}^{total} is a total number of elements in a first UCI part, N_{UCI-part2}^{total} is a total number of elements in a second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the coding rate of the first UCI part, and r₂ is the coding rate of the second UCI part. In Rel-16 new radio (NR), the number(s) of CRC bits are not included for the purpose of selecting a PUCCH resource set according to the payload size; in another word the payload size for the purpose of selecting PUCCH resource set does not include the CRC bits. Hence in Rel-17 it may also be possible to omit the number of CRC bits O_{UCI-part1,n} and/or O_{UCI-part2,n} in the payload when selecting a PUCCH resource and/or when determining power adjustment for power control.

Since in Rel-17, it may happen UCI Part I is with CRC protection (greater than 11 bits for UCI Part I), and UCI Part II is without CRC protection (less than or equal to 11 bits for UCI Part II), and vice versa. To address the UCI parts differing in whether CRC protection is included, how PUCCH transmission power is determined may be changed. In particular, how a PUCCH transmission power adjustment component (which may be referred to as a “power adjustment component”) of the PUCCH transmission power.

For example, a legacy PUCCH transmission power adjustment component for less than or equal to 11 UCI bits may be determined as:

For a PUCCH transmission using PUCCH format 2 or PUCCH format 3 or PUCCH format 4 and for a number of UCI bits smaller than or equal to 11, Δ_{TF,b,f,c}(i)=10 log₁₀(K₁·(n_{HARQ-ACK}(i)+O_{SR}(i)+O_{CSI}(i))/N_{RE}(i)), where Δ_{TF,b,f,c}(i) is the PUCCH transmission power adjustment component, K₁=6, n_{HARQ-ACK} is a number of hybrid automatic repeat request (HARQ)-acknowledgement (ACK) information bits, O_{SR}(i) is a number of scheduling request (SR) information bits, O_{CSI}(i) is a number of channel state information (CSI) information bits, and N_{RE}(i) is a number of resource elements.

The determination of the PUCCH transmission power adjustment component for less than or equal to 11 UCI bits may be changed to:

$${Δ}_{TF , b , f , c} ( i ) = 10 {log}_{10} ( {K}_{1} ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE} ( i ) ) ,$$

where K₁ is 6, N_{UCI-part1}^{total} is a total number of elements in a first UCI part, N_{UCI-part2}^{total} is a total number of elements in a second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the coding rate of the first UCI part, r₂ is the coding rate of the second UCI part, and N_{RE}(i) is a number of resource elements. Depending on the payloads in the first UCI Part and/or the second UCI Part, O_{CRC,UCI-part1} can be zero (for example when the number of payload bits in the first UCI part

$${\sum }_{n = 1}^{{N}_{UCI - part 1}^{total}} {O}_{UCI - part 1 , n}$$

is less than 12), and/or

$${\sum }_{n = 1}^{{N}_{UCI - part 1}^{total}} {O}_{UCI - part 1 , n} + {O}_{CRC , UCI - part 1}$$

can be zero (for example when the number of payload bits in the second UCI part

$${\sum }_{n = 1}^{{N}_{UCI - part 1}^{total}} {O}_{UCI - part 1 , n}$$

is less than 12). To avoid cumbersome notations, the index i for O_{UCI-part1,n}, O_{CRC,UCI-part1}, etc. has been dropped in the description.

A legacy PUCCH transmission power adjustment component for greater than 11 UCI bits may be determined as:
For a PUCCH transmission using PUCCH format 2 or PUCCH format 3 or PUCCH format 4 and for a number of UCI bits larger than 11, Δ_{TF,b,f,c}(i)=10 log₁₀(2^{K}^{₂}^{·BPRE(i)}−1), where Δ_{TF,b,f,c}(i) is the PUCCH transmission power adjustment component, K₂=2.4, and BPRE(i)=(O_{ACK}(i)+O_{SR}(i)+O_{CSI}(i)+O_{CRC})/N_{RE}(i). O_{ACK}(i) is a number of HARQ-ACK information bits, O_{SR} (i) is a number of SR information bits, O_{CSI}(i) is a number of CSI information bits, O_{CRC} is a number of CRC bits, and N_{RE}(i) is a number of resource elements.

The determination of the PUCCH transmission power adjustment component for greater than 11 UCI bits may have the determination of BPRE(i) changed to:

$$BPRE ( i ) = ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE} ( i ) ,$$

where N_{UCI-part1}^{total} is a total number of elements in a first UCI part, N_{UCI-part2}^{total} is a total number of elements in a second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the coding rate of the first UCI part, r₂ is the coding rate of the second UCI part, and N_{RE}(i) is a number of resource elements. Depending on the payloads in the first UCI Part and/or the second UCI Part, O_{CRC,UCI-part1} can be zero (for example when the number of payload bits in the first UCI part

$${\sum }_{n = 1}^{{N}_{UCI - part 1}^{total}} {O}_{UCI - part 1 , n}$$

is less than 12), O_{CRC,UCI-part2} can be zero (for example when the number of payload bits in the second UCI part

$${\sum }_{n = 1}^{{N}_{UCI - part 2}^{total}} {O}_{UCI - part 2 , n}$$

is less than 12).

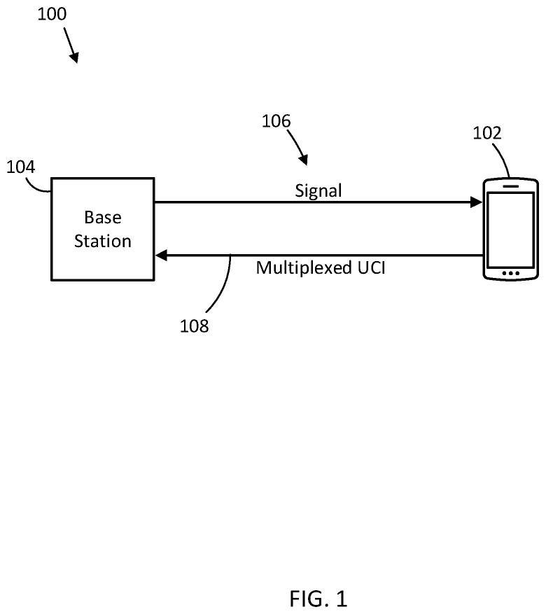

FIG. 1 illustrates an example network arrangement 100 in accordance with some embodiments. For example, the network arrangement 100 may comprise a portion of a network that may implement the PUCCH transmission power adjustment component changes described above.

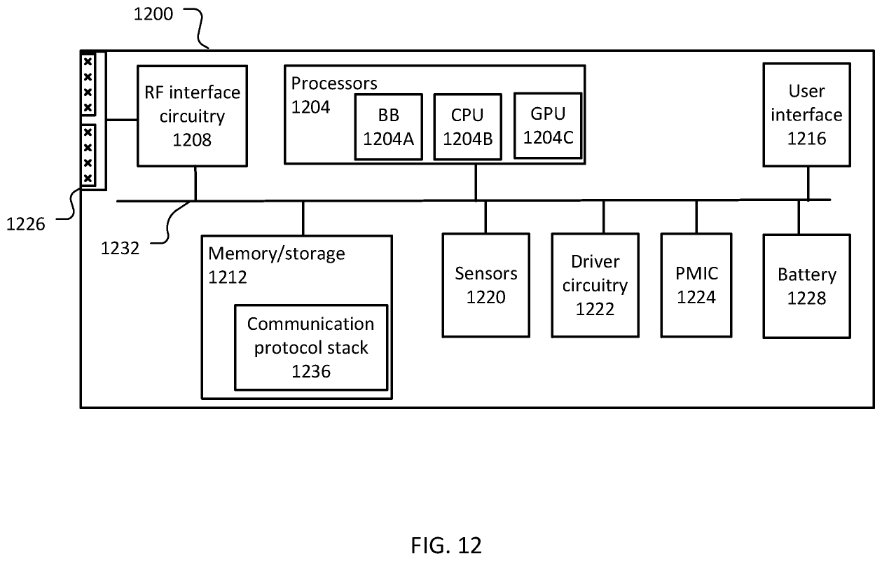

The network arrangement 100 may include a user equipment (UE) 102. The UE 102 may include one or more of the features of the UE 1200 (FIG. 12). In some embodiments, the UE 102 may comprise a smart phone that can provide a user with connection to a wireless area network (WAN). The user of the UE 102 may interact with the UE 102 to connect to the WAN.

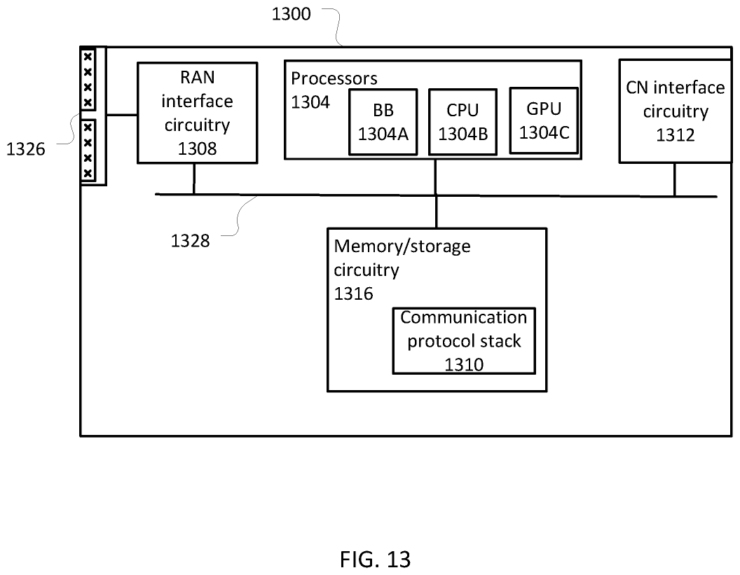

The network arrangement 100 may include a base station 104. The base station may comprise a nodeB, such as a next generation node B (gNB), a evolved nodeB (eNB), or another type of nodeB. The base station 104 may include one or more of the features of the gNB 1300 (FIG. 13). The base station 104 may provide WAN service to one or more UEs, such as the UE 102.

The UE 102 may establish a connection with the base station 104 to utilize WAN services provided by the base station 104. The UE 102 and the base station 104 may exchange signals 106 via the connection to support the WAN services. Of particular interest to this disclosure is a multiplexed UCI 108 that may be transmitted from the UE 102 to the base station 104. The multiplexed UCI 108 may include a first UCI part (which may be referred to as “UCI part I”) and a second UCI part (which may be referred to as “UCI part II”) as described further throughout this disclosure. The UE 102 may transmit the multiplexed UCI 108 via a PUCCH associated with the base station 104.

The UE 102 may determine a particular PUCCH transmission power with which the multiplexed UCI 108 is to be transmitted to the base station 104. In some embodiments, the UE 102 may determine the PUCCH transmission power for the multiplexed UCI 108 based on the equation

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{{O}_{PUCCH} b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{{F}_{PUCCH}} ( F ) + {Δ}_{TF , b , f , c} ( i ) + {ℊ}_{b , f , c} ( i , l )\end{matrix}\end{matrix} \} ,$$

where i is the PUCCH transmission occasion, P_{CMAX,f,c}(i) is the UE configured maximum output power, P_{O}_{_{PUCCU}}_{,b,f,c}(qᵤ) is a parameter composed of P_{O_NOMINAL_PUCCH} and P_{O_UE_PUCCH}(qᵤ) which may be provided to the UE as well known in the field, M_{RB,b,f,c}^{PUCCH}(i) is a bandwidth of a PUCCH resource assignment, PL_{b,f,c}(q_{d}) is a downlink pathloss, Δ_{F}_{_{PUCCH}} (F) is a value based on PUCCH format, Δ_{TF,b,f,c}(i) is a PUCCH transmission power adjustment component, and g_{b,f,c}(i, l) is a current PUCCH power control adjustment state.

However, legacy determination of the PUCCH transmission power adjustment component failed to address situations where the first UCI part and the second UCI part have different coding rates. Accordingly, the approach disclosed herein may involve the UE 102 taking into account the coding rates of the first UCI part and the second UCI part when determining the PUCCH transmission power adjustment component for a multiplexed UCI, such as the multiplexed UCI 108. For example, the UE 102 may determine a first coding rate for the first UCI part and a second coding rate for the second UCI part. The UE 102 may determine a ratio between the first coding rate to the second coding rate, and utilize the ratio to determine the PUCCH transmission power based on the ratio. Further, the UE 102 may determine the PUCCH transmission power based on a number of composite UCI bits within the multiplexed UCI in some instances. For example, the UE 102 may take into account the number of composite UCI bits within the multiplexed UCI when the PUCCH transmission in which multiplexed UCI is to be transmitted in PUCCH format 2, PUCCH format 3, or PUCCH format 4.

For example, in instances where a PUCCH transmission for the multiplexed UCI uses PUCCH format 2, PUCCH format 3, or PUCCH format 4 and for a number of composite UCI bits smaller than or equal to 11, the UE 102 may determine the PUCCH transmission power adjustment component for the multiplexed UCI 108 by

$${Δ}_{TF , b , f , c} ( i ) = 10 {log}_{10} ( {K}_{1} ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE} ( i ) ) ,$$

where N_{UCI-part1}^{total} is a total number of elements in a first UCI part, N_{UCI-part2}^{total} is a total number of elements in a second UCI part, O_{UCI-part1,n} is a number of bits of the first UCI part, O_{UCI-part2,n} is a number of bits of the second UCI part, r₁ is the coding rate of the first UCI part, and r₂ is the coding rate of the second UCI part, and N_{RE}(i) is a number of resource elements.

In instances where a PUCCH transmission for the multiplexed UCI uses PUCCH format 2, PUCCH format 3, or PUCCH format 4 and for a number of composite UCI bits is larger than 11, the UE 102 may determine the PUCCH transmission power adjustment component for the multiplexed UCI 108 by Δ_{TF,b,f,c}(i)=10 log₁₀(2^{K}^{₂}^{·BPRE(i)}−1), where Δ_{TF,b,f,c}(i) is the PUCCH transmission power adjustment component, K₂=2.4, and

$$BPRE ( i ) = ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE ( i )} ,$$

where N_{UCI-part1}^{total} is a total number of elements in a first UCI part, N_{UCI-part2}^{total} is a total number of elements in a second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the coding rate of the first UCI part, r₂ is the coding rate of the second UCI part, and N_{RE}(i) is a number of resource elements.

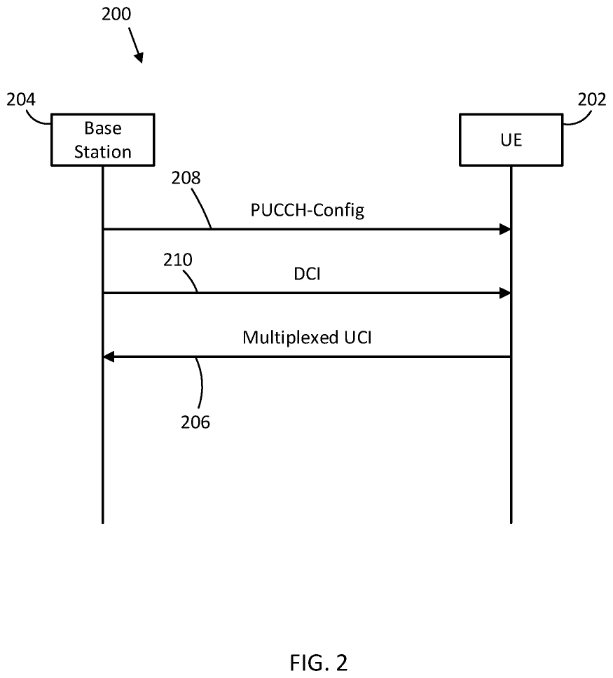

FIG. 2 illustrates an example signal chart 200 in accordance with some embodiments. In particular, the signal chart 200 illustrates a few signals that may be exchanged between a UE 202 and a base station 204 during operation. The UE 202 may include one or more of the features of the UE 102 (FIG. 1). The base station 204 may include one or more of the features of the base station 104 (FIG. 1).

The signal chart 200 may include a multiplexed UCI 206, where the UE 202 may transmit the multiplexed UCI 206 to the base station 204. The multiplexed UCI 206 may include one or more of the features of the multiplexed UCI 108 (FIG. 1). Further, the UE may determine the PUCCH transmission power adjustment component for the multiplexed UCI 206 as described in relation to the multiplexed UCI 108.

The signal chart 200 may include a PUCCH-Config message 208. The base station 204 may transmit the PUCCH-Config message 208 to the UE 202 prior to transmission of the multiplexed UCI 206. The PUCCH-Config message 208 may define a first coding rate for a first UCI part of the multiplexed UCI 206 and a second coding rate for a second UCI part of the multiplexed UCI 206. For example, the PUCCH-Config message 208 may include an information element that indicates the first coding rate for the first UCI part and the second coding rate for the second UCI part. The UE 202 may process the PUCCH-Config message 208 to determine the first coding rate for the first UCI part and the second coding rate for the second UCI part. In other embodiments, the PUCCH-Config message 208 may be omitted and the first UCI part and the second UCI part may be predefined.

The signal chart may further include DCI 210. The base station 204 may transmit the DCI 210 to the UE 202 prior to transmission of the multiplexed UCI 206. The DCI 210 may define a resource set for transmission of the multiplexed UCI 206. For example, the UCI 206 may include an information element that indicates the resource set for transmission of the multiplexed UCI 206. The UE 202 may process the DCI 210 to determine the resource set for transmission of the multiplexed UCI 206. In other embodiments, the PUCCH-Config message 208 and the DCI 210 may be included in a same message.

The UE 202 may process the PUCCH-Config message 208 and/or the DCI 210. In some embodiments, the UE 202 may determine the first coding rate for the first UCI part and the second coding rate for the second UCI part from the PUCCH-Config message 208. The UE 202 may determine the PUCCH transmission power adjustment component and the PUCCH transmission power for the multiplexed UCI 206 based on the first coding rate and the second coding rate in accordance with the approaches described throughout this disclosure. Further, the UE 202 may determine the resource set for transmission of the multiplexed UCI. The UE 202 may transmit the multiplexed UCI 206 to the base station 204 within the resource set in accordance with the determine PUCCH transmission power, which may be determined based on the PUCCH transmission power adjustment component. The UE 202 may transmit the multiplexed UCI 206 to the base station on a PUCCH corresponding to the base station 204.

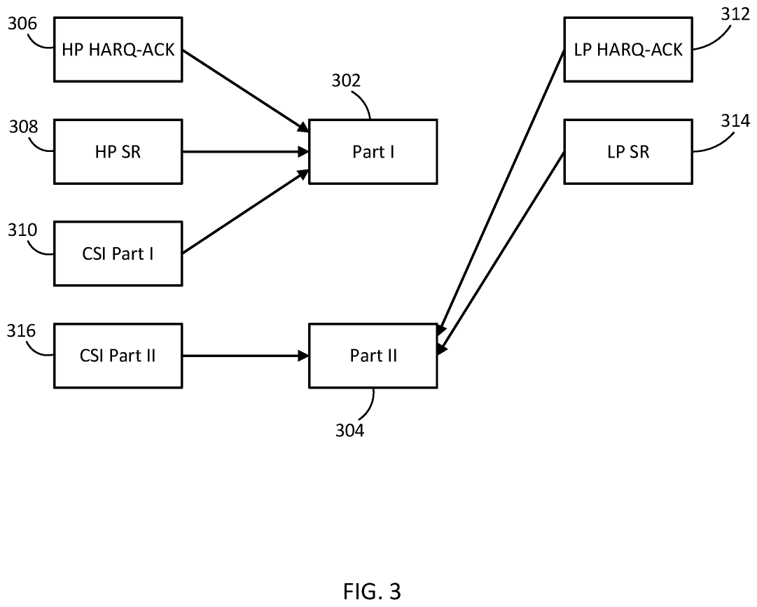

FIG. 3 illustrates example UCI parts in accordance with some embodiments. In particular, FIG. 3 illustrates a first UCI part 302 and a second UCI part 304. The first UCI part 302 and the second UCI part 304 may be multiplexed to produce a multiplexed UCI, such as the multiplexed UCI 108 (FIG. 1) and/or the multiplexed UCI 206 (FIG. 2).

Each of the UCI parts may include a HARQ-ACK UCI element, a scheduling request (SR) UCI element, and/or a channel state information (CSI) portion element. In particular, the first UCI part 302 may include a HP HARQ-ACK element 306, a HP SR element 308, and a CSI part 1 element 310 in the illustrated embodiment. Based on the first UCI part 302 including high priority elements (in particular, the HP HARQ-ACK element 306 and the HP SR element 308), the first UCI part 302 may include a CRC portion in some embodiments. The CRC portion may cause the first UCI part 302 to be larger than 11 composite UCI bits.

The second UCI part 304 may include a LP HARQ-ACK element 312, a LP SR element 314, and a CSI part 2 element 316 in the illustrated embodiment. The CSI part 1 element 310 and CSI part 2 element 316 may be a CSI that has been separated into two parts due to size. Based on the second UCI part 304 including low priority elements (in particular, the LP HARQ-ACK element 312 and the LP SR element 314), the second UCI part 304 may not have a CRC portion in some embodiments. Accordingly, the first UCI part 302 may include UCI elements having a first priority and the second UCI part 304 may include UCI elements having a second priority that is less than the first priority.

The multiplexed UCI may have a number of composite UCI bits based on the number of bits of the first UCI part 302 and the number of bits of the second UCI part 304. For example, if either or both of the first UCI part 302 and the second UCI part 304 includes CRC, the multiplexed UCI may have larger than 11 composite UCI bits. If both the first UCI part 302 and the second UCI part 304 do not include CRC, the multiplexed UCI may have less than or equal to 11 composite UCI bits. In other instances, the number of bits in the first UCI part 302 and the second UCI part 304 may be independent of whether CRC is included.

The first UCI part 302 and the second UCI part 304 may have different coding rates. For example, the first UCI part 302 may have a first coding rate and the second UCI part 304 may have a second coding rate in some embodiments, where the second coding rate is different from the first coding rate. A UE may determine a PUCCH transmission power adjustment component for transmission of the multiplexed UCI based on the first coding rate, the second coding rate, and/or the number of composite UCI bits of the multiplexed UCI. The UE may further determine the PUCCH transmission power based on the PUCCH transmission power adjustment.

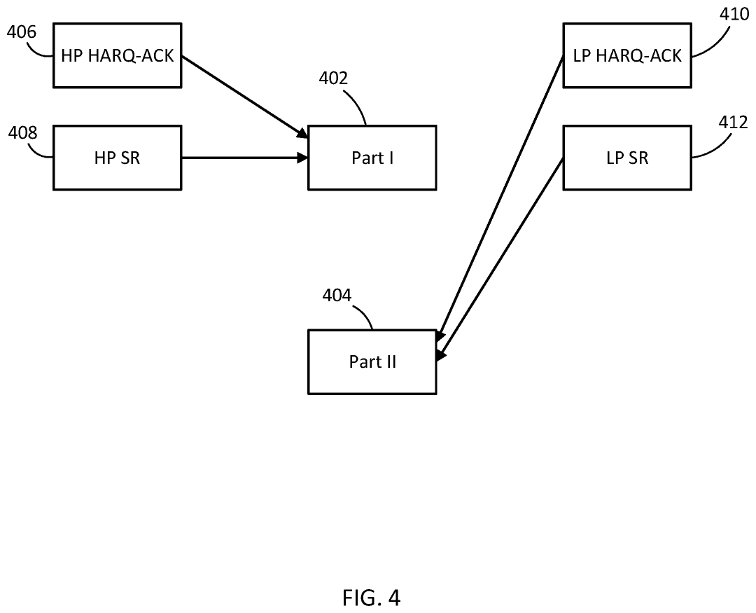

FIG. 4 illustrates another example UCI parts in accordance with some embodiments. In particular, FIG. 4 illustrates a first UCI part 402 and a second UCI part 404. The first UCI part 402 and the second UCI part 404 may be multiplexed to produce a multiplexed UCI, such as the multiplexed UCI 108 (FIG. 1) and/or the multiplexed UCI 206 (FIG. 2).

Each of the UCI parts may include a HARQ-ACK UCI element, a scheduling request (SR) UCI element, and/or a channel state information (CSI) portion element. In particular, the first UCI part 402 may include a HP HARQ-ACK element 406 and a HP SR element 408 in the illustrated embodiment. Based on the first UCI part 402 including high priority elements (in particular, the HP HARQ-ACK element 406 and the HP SR element 408), the first UCI part 402 may include a CRC portion in some embodiments. The CRC portion may cause the first UCI part 402 to be larger than 11 bits.

The second UCI part 404 may include a LP HARQ-ACK element 410 and a LP SR element 412 in the illustrated embodiment. Based on the second UCI part 404 including low priority elements (in particular, the LP HARQ-ACK element 410 and the LP SR element 412), the second UCI part 404 may not have a CRC portion in some embodiments. Accordingly, the first UCI part 402 may include UCI elements having a first priority and the second UCI part 404 may include UCI elements having a second priority that is less than the first priority.

The multiplexed UCI may have a number of composite UCI bits based on the number of bits of the first UCI part 402 and the number of bits of the second UCI part 404. For example, if either or both of the first UCI part 402 and the second UCI part 404 includes CRC, the multiplexed UCI may have larger than 11 composite UCI bits. If both the first UCI part 402 and the second UCI part 404 do not include CRC, the multiplexed UCI may have less than or equal to 11 composite UCI bits. In other instances, the number of bits in the first UCI part 402 and the second UCI part 404 may be independent of whether CRC is included.

The first UCI part 402 and the second UCI part 404 may have different coding rates. For example, the first UCI part 402 may have a first coding rate and the second UCI part 404 may have a second coding rate in some embodiments, where the second coding rate is different from the first coding rate. A UE may determine a PUCCH transmission power adjustment component for transmission of the multiplexed UCI based on the first coding rate, the second coding rate, and/or the number of composite UCI bits of the multiplexed UCI. The UE may further determine the PUCCH transmission power based on the PUCCH transmission power adjustment component.

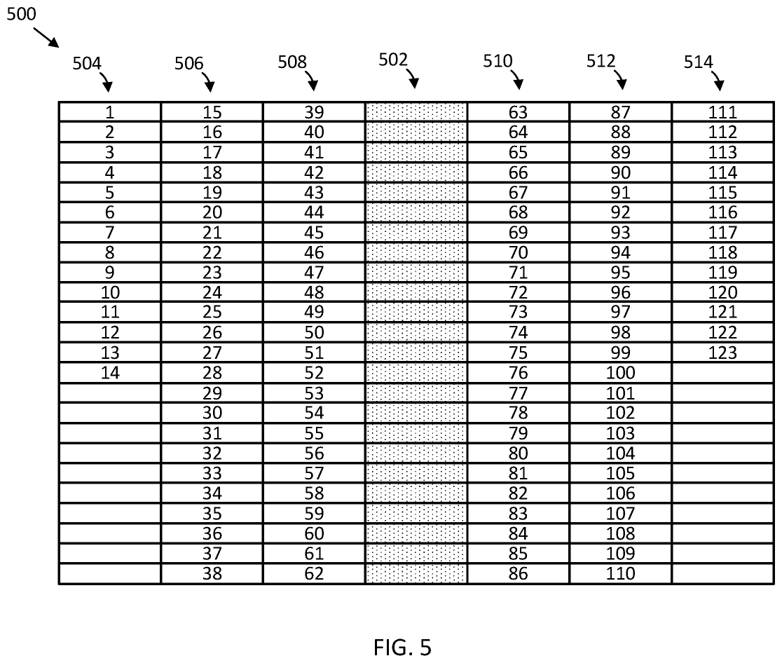

FIG. 5 illustrates example an orthogonal frequency division multiplexing (OFDM) symbol diagram 500 in PUCCH in accordance with some embodiments. For clarity and understanding, a portion of the OFDM symbols in PUCCH are shown in the OFDM symbol diagram 500.

The OFDM symbol diagram 500 may include demodulation reference signal (DMRS) symbols 502, which are utilized for transmission of DMRS. The OFDM symbol diagram 500 may include other symbols that are available for a multiplexed UCI (such as the multiplexed UCI 108 (FIG. 1) and/or the multiplexed UCI 206 (FIG. 2)). The other symbols are arranged into a first symbol column 504, a second symbol column 506, a third symbol column 508, a fourth symbol column 510, a fifth symbol column 512, and a sixth symbol column 514. The columns closer to the DMRS symbols 502 may be more desirable.

A DCI (such as the DCI 210 (FIG. 2)) may indicate the symbols to be utilized for transmission of the multiplexed UCI. For example, a base station (such as the base station 104 (FIG. 1) and/or the base station 204 (FIG. 2)) may transmit a DCI to a UE that indicates which of the other symbols the UE is to utilize to transmit the multiplexed UCI.

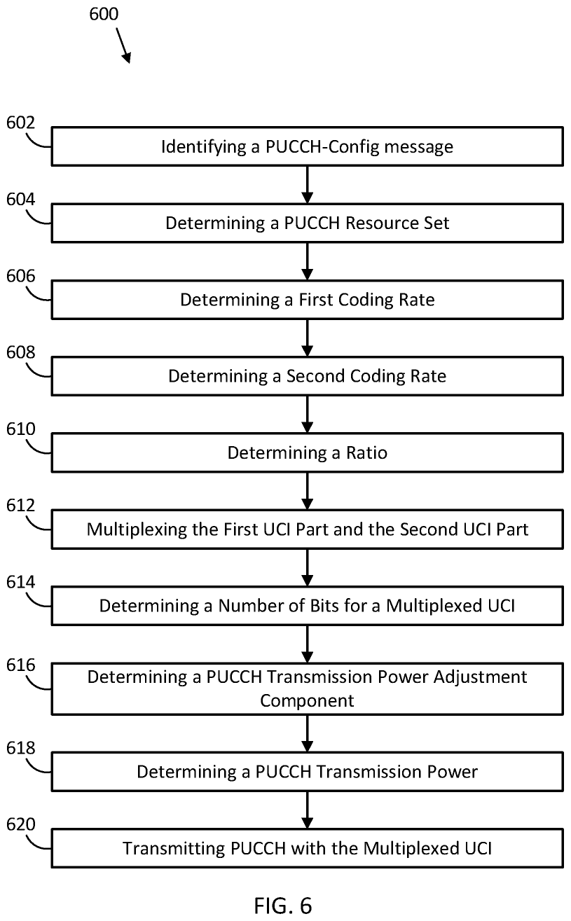

FIG. 6 illustrates an example procedure 600 for determining a PUCCH transmission power for a multiplexed UCI in accordance with some embodiments. A UE (such as the UE 102 (FIG. 1), the UE 202 (FIG. 2) and/or the UE 1200 (FIG. 12)) may perform the procedure 600 for transmission of the multiplexed UCI. The procedure 600 may apply the approaches described herein for determination of a PUCCH transmission power for the multiplexed UCI.

The procedure 600 may include identifying a PUCCH-Config message in 602. In particular, UE may identify a PUCCH-Config message received from a base station (such as the base station 104 (FIG. 1), the base station 204 (FIG. 2), and/or the gNB 1300 (FIG. 13). The PUCCH-Config message may indicate a first coding rate for a first UCI part (such as the first UCI part 302 (FIG. 3) and/or the first UCI part 402 (FIG. 4)) of a multiplexed UCI and a second coding rate for a second UCI part (such as the second UCI part 304 (FIG. 3) and/or the second UCI part 404 (FIG. 4)) of the multiplexed UCI. For example, the PUCCH-Config message may include an information element that indicates the first coding rate and the second coding rate in some embodiments. In some embodiments, 602 may be omitted.

In one option, r₁ and r₂ can be configured for a first UCI Part and a second UCI part under the high priority PUCCH-Config. In another option, r₁ and r₂ can be configured for a first UCI Part and a second UCI part for a PUCCH resource set under the high priority PUCCH-Config, different PUCCH resource sets may have different pairs of r₁ and r₂. In yet another option, r₁ and r₂ can be configured for a first UCI Part and a second UCI part for a PUCCH format under the high priority PUCCH-Config. With another option, r₁ and r₂ can be configured for a first UCI Part and a second UCI part for a PUCCH resource under the high priority PUCCH-Config.

The procedure 600 may further include determining a PUCCH resource set in 604. In particular, the UE may determine a PUCCH resource set for transmission of the multiplexed UCI. The UE may determine a PUCCH resource within the determined PUCCH resource set based on DCI received from the base station. For example, the base station may indicate, via the DCI, an indication for the PUCCH resource for transmission of the multiplexed UCI. The UE may process the DCI from the base station to determine the PUCCH resource. In some embodiments, 604 may be omitted

The procedure 600 may further include determining the first coding rate in 606. In particular, a UE may determine the first coding rate for a first UCI part to be multiplexed in a PUCCH transmission. In some embodiments, the UE may process the PUCCH-Config message identified in 602 to determine the first coding rate.

The procedure 600 may further include determining a second coding rate in 608. In particular, the UE may determine the second coding rate for a second UCI part to be multiplexed in the PUCCH transmission. In some embodiments, the first UCI part may include high priority elements and the second UCI part may include low priority element. Further, the UE may process the PUCCH-Config message identified in 602 to determine the second coding rate in some embodiments. Accordingly, the first UCI part may include UCI elements having a first priority and the second UCI part may include UCI elements having a second priority that is lower than the first priority.

If two CSI of two parts are included, then it may happen the two parts of CSI are encoded with different coding rates depending where the UCI is carried: first UCI part or second UCI part. Assuming r₁ is the coding rate for the first UCI part and r₂ is the coding rate for the second UCI part. In one option, r₁ and r₂ can be configured for first UCI Part and second UCI part under the high priority PUCCH-Config. In another option, r₁ and r₂ can be configured for UCI Part 1 and UCI part 2 for a PUCCH resource set under the high priority PUCCH-Config, different PUCCH resource sets may have different pairs of r₁ and r₂. In yet another option, r₁ and r₂ can be configured for UCI Part 1 and UCI part 2 for a PUCCH format under the high priority PUCCH-Config; With another option, r₁ and r₂ can be configured for UCI Part 1 and UCI part 2 for a PUCCH resource under the high priority PUCCH-Config;

The procedure 600 may further include determining a ratio in 610. In particular, the UE may determine a ratio of the first coding rate to the second coding rate. The UE may determine the ratio by dividing the second coding rate by the first coding rate, or dividing the first coding rate by the second coding rate, in some embodiments.

The procedure 600 may further include multiplexing the first UCI part and the second UCI part in 612. In particular, the UE may multiplex the first UCI part and the second UCI part to produce a multiplexed UCI (such as the multiplexed UCI 108 (FIG. 1) and/or the multiplexed UCI 206 (FIG. 2)). The UE may produce the multiplexed UCI for transmission on the PUCCH transmission. The UE may produce the multiplexed UCI in accordance with a PUCCH format 2, a PUCCH format 3, or a PUCCH format 4 in some embodiments. In some embodiments, 612 may be omitted.

The procedure 600 may further include determining a number of composite UCI bits for the multiplexed UCI in 614. For example, the UE may determine the number of the composite UCI bits in the multiplexed UCI. In some embodiments, the UE may determine whether the number of composite UCI bits is less than or equal to a certain number of bits or whether the number of composite UCI bits is greater than a certain number of bits. For example, the UE may determine whether the number of composite UCI bits is less than or equal to 11 bits or whether the number of composite UCI bits is greater than 11 bits in some embodiments. In some embodiments, the number of composite UCI bits may be determined based on

$$( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) ,$$

where N_{UCI-part1}^{total} is the total number of elements in the first UCI part, N_{UCI-part2}^{total} is the total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the first coding rate of the first UCI part, and r₂ is the second coding rate of the second UCI part. In some embodiments, 614 may be omitted.

The procedure 600 may further include determining a PUCCH transmission power adjustment component in 616. For example, the UE may determine the PUCCH transmission power adjustment component in accordance with the approaches for determining a PUCCH transmission power adjustment component described throughout this disclosure. The UE may determine the PUCCH transmission power adjustment component based on the ratio determined in 610. In particular, the ratio of the first coding rate to the second coding rate determined in 610 may be utilized as the ratio of coding rates for determining the PUCCH transmission power adjustment component described throughout this disclosure.

In some embodiments, the UE may further determine the PUCCH transmission power adjustment component based on the number of composite UCI bits for the multiplexed UCI determined in 618. In particular, the UE may apply one calculation for determining the PUCCH transmission power adjustment component when the number of composite UCI bits of the multiplexed UCI is less than or equal to a certain number, and may apply another calculation for determining the PUCCH transmission power adjustment component when the number of composite UCI bits of the multiplexed UCI is greater than the certain number, as described further throughout this disclosure. In some embodiments, the UE may apply the first calculation for the number of composite UCI bits for the multiplexed UCI being less than or equal to 11 and the second calculation for the number of composite UCI bits of the multiplexed UCI being greater than 11. Further, the UE may apply the ratio to the bits for the multiplexed UCI and CRC bits of the multiplexed UCI when the number of bits is greater than 11, and may apply the ratio to bits for the multiplexed UCI when the number of bits is less than or equal to 11 in some embodiments. In some embodiments, the UE may apply the ratio to a bits for the first UCI part and avoid application of the ratio to the bits of the second UCI part, or vice versa, in some embodiments.

In some embodiments, the UE may determine the PUCCH transmission power adjustment component for a number of composite UCI bits of a multiplexed UCI produced via multiplexing of the first UCI part and the second UCI part being less than or equal to 11 based on

$${Δ}_{TF , b , f , c} ( i ) = 10 {log}_{10} ( {K}_{1} ( ( {\sum }_{n = 1}^{{N}_{UCI - part 2}^{total}} {O}_{UCI - part 2 , n} + {O}_{CRC , UCI - part 2} ) {r}_{1} / {r}_{2} + {\sum }_{n = 1}^{{N}_{UCI - part 1}^{total}} {O}_{UCI - part 1 , n} + {O}_{CRC , UCI - part 1} ) ) / {N}_{RE} ( i ) ) ,$$

where N_{UCI-part1}^{total} is a total number of elements in a first UCI part, N_{UCI-part2}^{total} is a total number of elements in a second UCI part, O_{UCI-part1,n} is a number of bits of the first UCI part, O_{UCI-part2,n} is a number of bits of the second UCI part, r₁ is the coding rate of the first UCI part, and r₂ is the coding rate of the second UCI part, and N_{RE}(i) is a number of resource elements. Further, the UE may determine the PUCCH transmission power adjustment component for a number of composite UCI bits greater than 11 based on

$$BPRE ( i ) = ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE ( i )} ,$$

where N_{UCI-part1}^{total} is a total number of elements in a first UCI part, N_{UCI-part2}^{total} is a total number of elements in a second UCI part, O_{UCI-part1,n}, n=1, . . . , N_{UCI-part1}^{total} is a number of bits of the first UCI part excluding cyclic redundancy check (CRC) bits, O_{CRC,UCI-part1} is a number of bits of the CRC in the first UCI part, O_{UCI-part2,n}, n=1, . . . , N_{UCI-part2}^{total} is a number of bits of the second UCI part excluding CRC bits, O_{CRC,UCI-part2} is a number of bits of the CRC in the second UCI part, r₁ is the coding rate of the first UCI part, r₂ is the coding rate of the second UCI part, and N_{RE}(i) is a number of resource elements. If the number of payload size in first UCI part

$$( {\sum }_{n = 1}^{{N}_{UCI - part 1}^{total}} {O}_{UCI - part 1 , n} )$$

is no larger than 11, yet the number of payload size in second UCI part

$$( {\sum }_{n = 1}^{{N}_{UCI - part 2}^{total}} {O}_{UCI - part 2 , n} )$$

is larger than 11, then

$$BPRE ( i ) = ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} ) ) / {N}_{RE ( i )} .$$

If the number of payload size in the first UCI part

$$( {\sum }_{n = 1}^{{N}_{UCI - part 1}^{total}} {O}_{UCI - part 1 , n} )$$

is larger than 11, yet the number of payload size in the second UCI part

$$( {\sum }_{n = 1}^{{N}_{UCI - part 2}^{total}} {O}_{UCI - part 2 , n} )$$

is no larger than 11, then

$$BPRE ( i ) = ( ( {\sum }_{n = 1}^{{N}_{UCI - part 2}^{total}} {O}_{UCI - part 2 , n} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE ( i )} .$$

Alternatively, for each HARQ codebook, one can derive n_{HARQ-ACK}(i) for it, n_{HARQ-ACK}(i) can be found through the procedure given Clause 7.2.1, in TS 38.213. Then n_{HARQ-ACK}(i) instead of O_{ACK}(i) can be used for the first UCI part or the second UCI part or both the first UCI part and the second UCI part, by replacing the number of HARQ bits as given by O_{UCI-part1,n} or O_{UCI-part2,n} by corresponding n_{HARQ-ACK}(i) values for each HARQ codebook, for example when a number of composite UCI bits of a multiplexed UCI produced via multiplexing of the first UCI part and the second UCI part being less than or equal to 11.

The composite UCIs can include the contribution from CRC bits fully or in part, or exclude the contribution from CRC bits, a few choices are given for counting the number of composite UCI bits:

$$( ( {\sum }_{n = 1}^{{N}_{UCI - part 2}^{total}} {O}_{UCI - part 2 , n} + {O}_{CRC , UCI - part 2} ) ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) ,$$

$$( ( {\sum }_{n = 1}^{{N}_{UCI - part 1}^{total}} {O}_{UCI - part 1 , n} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) ,$$

$$( ( {\sum }_{n = 1}^{{N}_{UCI - part 2}^{total}} {O}_{UCI - part 2 , n} + {O}_{CRC , UCI - part 2} ) ) {r}_{1} / {r}_{2} + ( {\sum }_{n = 1}^{{N}_{UCI - part 1}^{total}} {O}_{UCI - part 1 , n} ) ) ,$$

$$( ( {\sum }_{n = 1}^{{N}_{UCI - part 2}^{total}} {O}_{UCI - part 2 , n} ) {r}_{1} / {r}_{2} + ( {\sum }_{n = 1}^{{N}_{UCI - part 1}^{total}} {O}_{UCI - part 1 , n} ) ) .$$

When the number of composite UCI bits is counted through

$$( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) ,$$

then if

$$( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - parr 1} ) ) \leq 11 ,$$

it is guaranteed there is no CRC bits in UCI part 1 (or the number of CRC bits for UCI part 1 is zero).

In one example,

$${\sum }_{n = 1}^{{N}_{UCI - part 1}^{total}} {O}_{UCI - part 1 , n} = 1 ,$$

$${O}_{CRC , UCI - part 1} = 0 ,$$

$${\sum }_{n = 1}^{{N}_{UCI - part 2}^{total}} {O}_{UCI - part 2 , n} = 12 ,$$

$${O}_{CRC , UCI - part 2} = 6 ,$$

$$\frac{{r}_{1}}{{r}_{2}} = 1 / 3 ,$$

$$( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UC1 - part 1} ) ) = ( 1 + {( 12 + 6 )}^{*} 1 / 3 ) = 1 + 6 = 7 < 11 ,$$

hence O_{CRC,UCI-part2} may not be zero yet the condition to use the first formula is satisfied, hence

$${Δ}_{TF , b , f , c} ( i ) = 10 {log}_{10} ( {K}_{1} ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} ) ) / {N}_{RE} ( i ) ) .$$

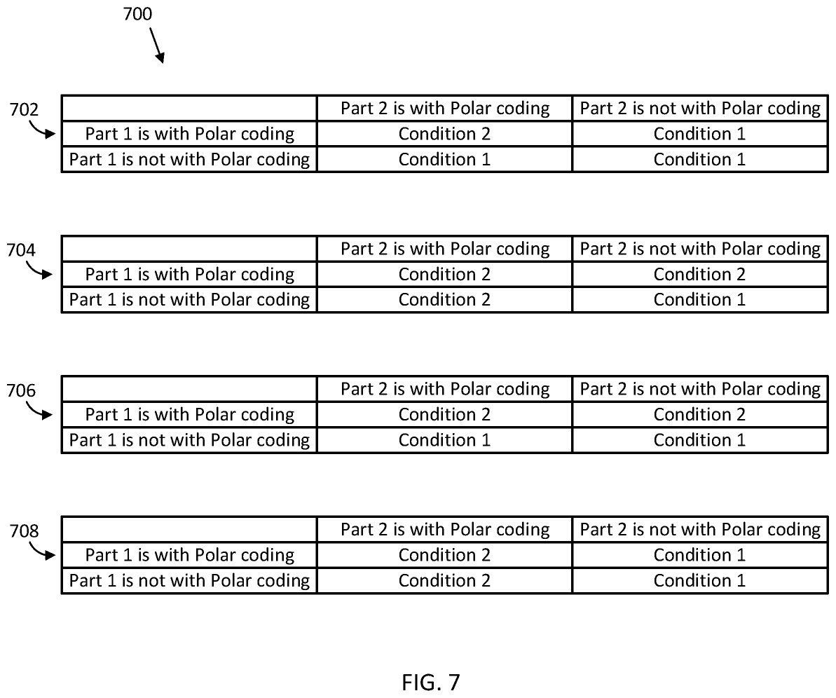

In some embodiments, instead of using the composite UCI bits as the criterion to decide which formula to use, as described above, the channel coding scheme(s) for the first UCI part and the second UCI part may be utilized as criterion for determining an equation to be utilized for determining the power adjustment component for the PUCCH transmission power. FIG. 7 illustrates example tables 700 for determining the equation to be utilized when using the coding schemes for the first UCI part and the second UCI part as criterion in accordance with some embodiments. The reference to “Condition 1” and “Condition 2” within the tables 700 may indicate which of the equations is to be utilized as described further below. In some embodiments, polar coding within the table may reference whether the UCI part includes CRC bits. For example, a UCI part with polar coding may include CRC bits, whereas a UCI part that is not with polar coding may not include CRC bits.

The tables 700 include a first table 702 that illustrates a first option for determining the equation to be utilized for determining the power adjustment component. As illustrated in the first table 702, when the first UCI part and the second UCI part is with polar coding, the equation corresponding to condition 2 may be applied to determine the power adjustment component. When the either or both of the first UCI part and the second UCI is not with polar coding, the equation corresponding to condition 1 may be applied to determine the power adjustment component.

The tables 700 include a second table 704 that illustrates a second option for determining the equation to be utilized for determining the power adjustment component. As illustrated in the second table 704, when either or both of the first UCI part and the second UCI part are with polar coding, the equation corresponding to condition 2 may be applied to determine the power adjustment component. When both the first UCI part and the second UCI part are not with polar coding, the equation corresponding to the condition 1 may be applied to determine the power adjustment component.

The tables 700 include a third table 706 that illustrates a third option for determining the equation to be utilized for determining the power adjustment component. As illustrated in the third table 706, when the first UCI part is with polar coding, the equation corresponding to condition 2 may be applied to determine the power adjustment component. When the first UCI part is not with polar coding, the equation corresponding to the condition 1 may be applied to determine the power adjustment component.

The tables 700 include a fourth table 708 that illustrates a fourth option for determining the equation to be utilized for determining the power adjustment component. As illustrated in the fourth table 708, when the second UCI part is with polar coding, the equation corresponding to condition 2 may be applied to determine the power adjustment component. When the second UCI part is not with polar coding, the equation corresponding to condition 1 may be applied to determine the power adjustment component.

When condition 1 is met, the power adjustment component may be determined by the UE based on

$${Δ}_{TF , b , f , c} ( i ) = 10 log 10 ( {K}_{1} ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE} ( i ) ,$$

where K₁ is 6, N_{UCI-part1}^{total} is a total number of elements in a first UCI part, N_{UCI-part2}^{total} is a total number of elements in a second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the coding rate of the first UCI part, r₂ is the coding rate of the second UCI part, and N_{RE}(i) is a number of resource elements. Depending on the payloads in the first UCI Part and/or the second UCI Part, O_{CRC,UCI-part1} can be zero (for example when the number of payload bits in the first UCI part

$${\sum }_{n = 1}^{{N}_{UCI - part 1}^{total}} {O}_{UCI - part 1 , n}$$

is less than 12), and/or

$${\sum }_{n = 1}^{{N}_{UCI - part 1}^{total}} {O}_{UCI - part 1 , n} + {O}_{CRC , UCI - part 1}$$

can be zero (for example when the number of payload bits in the second UCI part

$${\sum }_{n = 1}^{{N}_{UCI - part 1}^{total}} {O}_{UCI - part 1 , n}$$

is less than 12).

When the condition 2 is met, the power adjustment component may be determined by the UE based on, Δ_{TF,b,f,c}(i) 10 log₁₀(2^{K}^{₂}^{·BPRE(i)}−1), where

$${K}_{2} = 2.4$$

$$BPRE ( i ) = ( ( {\sum }_{n = 1}^{{N}_{UCI - part 2}^{total}} {O}_{UCI - part 2 , n} + {O}_{CRC , UCI - part 2} ) + ( {\sum }_{n = 1}^{{N}_{UCI - part 2}^{total}} {O}_{UCI - part 1 , n} + {O}_{CRC , UCI - part 1} ) / {N}_{R E ( i )} ,$$

where N_{UCI-part1}^{total} is a total number of elements in a first UCI part, N_{UCI-part2}^{total} is a total number of elements in a second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the coding rate of the first UCI part, r₂ is the coding rate of the second UCI part, and N_{RE}(i) is a number of resource elements. Depending on the payloads in the first UCI Part and/or the second UCI Part, O_{CRC,UCI-part1} can be zero (for example when the number of payload bits in first UCI part

$${\sum }_{n = 1}^{{N}_{UCI - part 1}^{total}} {O}_{UCI - part 1 , n}$$

is less than 12),

$${\sum }_{n = 1}^{{N}_{UCI - part 1}^{total}} {O}_{UCI - part 1 , n} + {O}_{CRC , UCI - part 1}$$

can be zero (for example when the number of payload bits in the second UCI part

$${\sum }_{n = 1}^{{N}_{UCI - part 1}^{total}} {O}_{UCI - part 1 , n}$$

is less than 12).

In another embodiment, in FIG. 7, “Part 1 is with polar coding” can be replaced with “the number of UCI bits for each UCI part 1 excluding CRC bits is larger than 11”, “Part 1 is not with polar coding” can be replaced with “the number of UCI bits for each UCI part 1 excluding CRC bits is not larger than 11”, “Part 2 is with polar coding” can be replaced with “the number of UCI bits for each UCI part 2 excluding CRC bits is larger than 11”, “Part 2 is not with polar coding” can be replaced with “the number of UCI bits for each UCI part 2 excluding CRC bits is not larger than 11”, so the condition status is derived from the number of UCI bits excluding CRC bits in one UCI part or both UCI parts.

Alternatively, for each HARQ codebook, one can derive n_{HARQ-ACK}(i) for it, n_{HARQ-ACK}(i) can be found through the procedure given Clause 7.2.1, in TS 38.213. Then n_{HARQ-ACK}(i) instead of O_{ACK}(i) can be used for the first UCI part or the second UCI part or both the first UCI part and the second UCI part, by replacing the number of HARQ bits as given by O_{UCI-part1,n} or O_{UCI-part2,n} by corresponding n_{HARQ-ACK}(i) values for each HARQ codebook, for example when condition 1 is met.

In some embodiments, since the first UCI part and the second UCI part are separately encoded, the delta factor can be separately determined for each UCI part first. To avoid power spectral density change in the frequency domain and/or time domain, then the larger one between them is applied for both UCI parts. Alternatively, only the delta factor for UCI part 1 or UCI part 2 is applied to both UCI parts. To derive the delta factor for each UCI part, its payload size and the number of used RE resource elements for that UCI part need to be identified. Instead of using N_{RE}(i), which is the total number of resource elements to carry both UCI parts, a UCI part specific resource element parameter, N_{RE_part1}(i), N_{RE-part2}(i), can be used for each part.

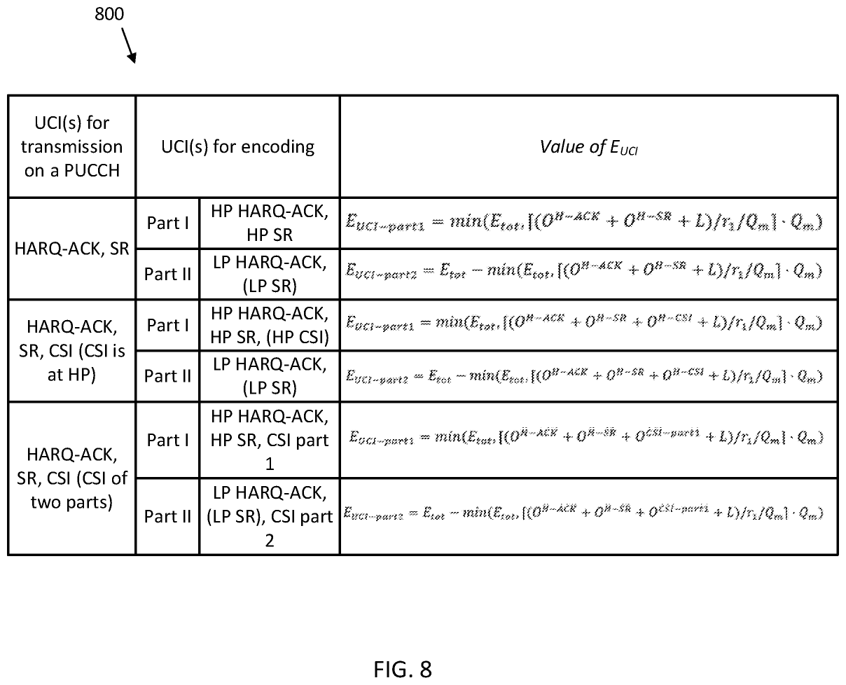

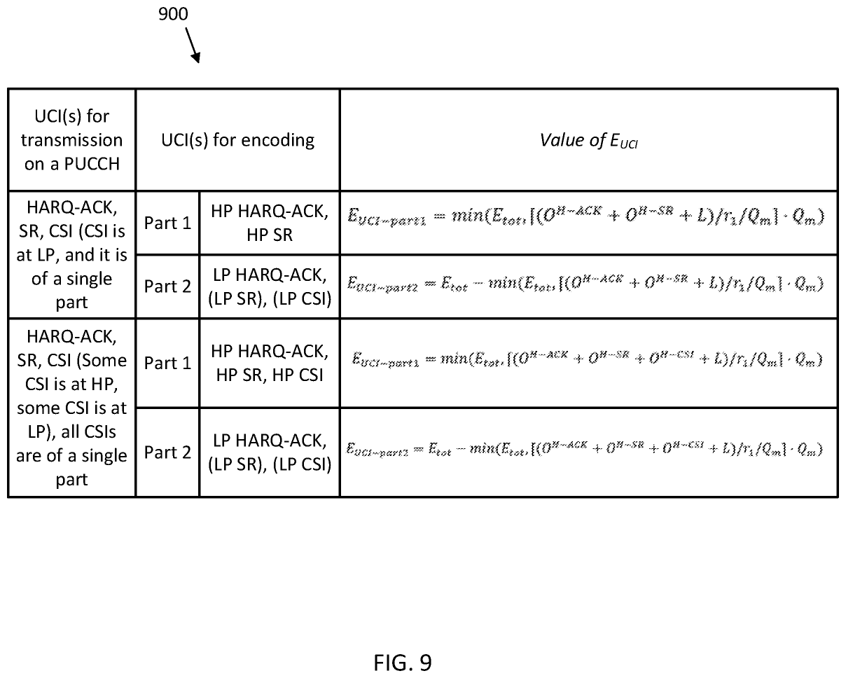

FIG. 8 illustrates an example table 800 that illustrates UCI mappings for separate encoding in accordance with some embodiments. FIG. 9 illustrates an example table 900 that illustrates additional UCI mappings for separate encoding in accordance with some embodiments. In particular, the tables illustrate E_{UCI} values that may be utilized for determining a number of resource elements for carrying the UCI parts. The determined number of resource elements may be utilized by the UE to determine the power adjustment component, as discussed further below.

The table 800 illustrates that for a UCI transmission that includes HARQ-ACK and SR, the first UCI part and the second UCI part may have different E_{UCI} values. For example, the first UCI part may include HP HARQ-ACK and HP SR, and the value of E_{UCI} for the first UCI part may be determined based on the equation E_{UCI-part1}=min(Eₜₒₜ,┌(O^{H-ACK}+O^{H-SR}+L)/r₁/Qₘ┐·Qₘ). The second UCI part may include LP HARQ-ACK, and LP SR may be optionally included in the second UCI part, and the value of E_{UCI} for the second UCI part may be determined based on the equation E_{UCI-part2}=Eₜₒₜ−min(Eₜₒₜ,┌(O^{H-ACK}+O^{H-SR}+L)/r₁/Qₘ┐·Qₘ).

The table 800 illustrates that for a UCI transmission that includes HARQ-ACK, SR, and CSI at HP, the first UCI part and the second UCI part may have different E_{UCI} values. For example, the first UCI part may include HP HARQ-ACK and HP SR, and may optionally include HP CSI, and the value of E_{UCI} for the first UCI part may be determined based on the equation E_{UCI-part1}=min(Eₜₒₜ,┌(O^{H-ACK}+O^{H-SR}+L)/r₁/Qₘ┐·Qₘ). The second UCI part may include LP HARQ-ACK, and may optionally include LP SR, and the value of E_{UCI} for the second UCI part may be determined based on the equation E_{UCI-part2}=Eₜₒₜ−min(Eₜₒₜ,┌(O^{H-ACK}+O^{H-SR}+L)/r₁/Qₘ┐·Qₘ).

The table 800 illustrates that for a UCI transmission that includes HARQ-ACK, SR, and CSI of two parts, the first UCI part and the second UCI part may have different E_{UCI} values. For example, the first UCI part may include HP HARQ-ACK, HP SR, and a first CSI part, and the value of E_{UCI} for the first UCI part may be determined based on the equation E_{UCI-part1}=min(Eₜₒₜ,┌(O^{H-ACK}+O^{H-SR}+L)/r₁/Qₘ┐·Qₘ). The second UCI part may include LP HARQ-ACK and a second CSI part, and may optionally include LP SR, and the value of E_{UCI} for the second UCI part may be determined based on the equation E_{UCI-part2}=Eₜₒₜ−min(Eₜₒₜ,┌(O^{H-ACK}+O^{H-SR}+L)/r₁/Qₘ┐·Qₘ).

The table 900 illustrates that for a UCI transmission that includes HARQ-ACK, SR, and CSI at LP that is of a single part, the first UCI part and the second UCI part may have different E_{UCI} values. For example, the first UCI part may include HP HARQ-ACK and HP SR, and the value of E_{UCI} for the first UCI part may be determined based on the equation E_{UCI-part1}=min(Eₜₒₜ,┌(O^{H-ACK}+O^{H-SR}+L)/r₁/Qₘ┐·Qₘ). The second UCI part may include LP HARQ-ACK, and may optionally include LP SR and LP CSI, and the value of E_{UCI} for the second UCI part may be determined based on the equation E_{UCI-part2}=Eₜₒₜ−min(Eₜₒₜ,┌(O^{H-ACK}+O^{H-SR}+L)/r₁/Qₘ┐·Qₘ).

The table 900 illustrates that for a UCI transmission that includes HARQ-ACK, SR, and CSI where some of the CSI is at HP and some of the CSI is at LP, and all of the CSIs are of a single part, the first UCI part and the second UCI part may have different E_{UCI} values. For example, the first UCI part may include HP HARQ-ACK, HP SR, and HP CSI, and the value of E_{UCI} for the first UCI part may be determined based on the equation E_{UCI-part1}=min(Eₜₒₜ,┌(O^{H-ACK}+O^{H-SR}+L)/r₁/Qₘ┐·Qₘ). The second UCI part may include LP HARQ-ACK, and may optionally include LP SR and LP CSI, and the value of E_{UCI} for the second UCI part may be determined based on the equation E_{UCI-part2}=Eₜₒₜ−min(Eₜₒₜ,┌(O^{H-ACK}+O^{H-SR}+L)/r₁/Qₘ┐·Qₘ).

In the table 800 and table 900, L is the number of CRC bits which can be zero, Qₘ is the modulation order. For PUCCH format 2 and format 3

$${E}_{tot} = {N}_{RE} ( i ) \cdot {Q}_{m} ,$$

$${N}_{RE - part 1} = \frac{{E}_{UCI - part 1}}{{Q}_{m}} ;$$

$${N}_{RE - part 2} = \frac{{E}_{UCI - part 2}}{{Q}_{m}} .$$

For PUCCH format 4

$${E}_{tot} = {N}_{RE} ( i ) \cdot \frac{{Q}_{m}}{{N}_{SF}^{PUCCH , 4}} ,$$

where N_{SF}^{PUCCH,4} is me spreading factor for PUCCH format 4,

$${N}_{RE - part 1} = \frac{{E}_{UCI - part 1} {N}_{SF}^{PUCCH , 4}}{{Q}_{m}} ; {N}_{RE - part 2} = \frac{{E}_{UCI - part 2} {N}_{SF}^{PUCCH , 4}}{{Q}_{m}} .$$

Alternatively, to calculate N_{RE-part1} and N_{RE-part2}: for PUCCH formats 2/3/4,

$${N}_{RE - part 1} = \frac{{E}_{UCI - part 1} {N}_{RE} ( i )}{{E}_{tot}} ; {N}_{RE - part 2} = \frac{{E}_{UCI - part 2} \cdot {N}_{RE} ( i )}{{E}_{tot}} .$$

The UE may utilize the determined values of E_{UCI} from the table to determine the number of resources, N_{RE}, values that are utilized for determining the power adjustment component. For example, the UE may utilize the determined values of E_{UCI} to determine the number of resources of the first UCI part, N_{RE-part1}(i), and/or the number of resources of the second UCI part, N_{RE-part2}(i), that may be utilized for determining the power adjustment component.

For example, the UE may determine the power adjustment component based on if

$${\sum }_{n = 1}^{{N}_{UCI - part 1}^{total}} {O}_{UCI - part 1 , n}$$

is smaller or equal to 11,

$${Δ}_{TF , b , f , c , part 1} ( i ) = 10 \cdot {log}_{10} ( {K}_{1} \cdot ( {\sum }_{n = 1}^{{N}_{UCI - part 1}^{total}} {O}_{UCI - p a r t 1 , n} ) / {N}_{R E - part 1} ( i ) )$$

$$otherwise ,$$

$${Δ}_{TF , b , f , c , part 1} ( i ) = 10 {log}_{10} ( {2}^{{K}_{2} \cdot BPR E ( i )} - 1 ) where$$

$$- {K}_{2} = 2.4 and$$

$$BPRE ( i ) = ( {\sum }_{n = 1}^{{N}_{UCI - part 1}^{total}} {O}_{U C I - p a r t 1 , n} + {O}_{C R C , U C I - p a r t 1} ) / {N}_{R E - part 1 ( i )}$$

if

$${\sum }_{n = 1}^{{N}_{UCI - part 2}^{total}} {O}_{U C I - part 2 , , n}$$

is smaller or equal to 11,

$${Δ}_{TF , b , f , c , part 2} ( i ) = 10 \cdot {log}_{10} ( {K}_{1} \cdot ( {\sum }_{n = 1}^{{N}_{UCI - part 1}^{total}} {O}_{UCI - part 2 , , n} ) / {N}_{RE - part 2} ( i ) ) otherwise ,$$

$${Δ}_{TF , b , f , c , part 2} ( i ) = 10 {log}_{10} ( {2}^{{K}_{2} \cdot BPRE ( i )} - 1 ) , where$$

$${K}_{2} = 2.4 and$$

$$BPRE ( i ) = ( {\sum }_{n = 1}^{{N}_{UCI - part 2}^{total}} {O}_{UCI - part 2 , n} + {O}_{CRC , UCI - part 2} ) / {N}_{RE - part 2 ( i )}$$

$$And {Δ}_{TF , b , f , c} ( i ) = max ( {Δ}_{TF , b , f , c , part 1} ( i ) , {Δ}_{TF , b , f , c , part 2} ( i ) ) . Alternatively {Δ}_{TF , b , f , c} ( i ) = {Δ}_{TF , b , f , c , part 1} ( i ) ,$$

$$or {Δ}_{TF , b , f , c} ( i ) = {Δ}_{TF , b , f , c , part 2} ( i ) .$$

The procedure 600 may include determining a PUCCH transmission power in 618. In particular, the UE may determine the PUCCH transmission power for the multiplexed UCI on the PUCCH transmission in accordance with the approaches for determining the PUCCH transmission power described throughout this disclosure. The UE may determine the PUCCH transmission power based on the PUCCH transmission power adjustment component determining in 616.

The procedure 600 may include transmitting PUCCH with the multiplexed UCI in 620. In particular, the UE may transmit a PUCCH transmission with the multiplexed UCI to the base station via the PUCCH. The UE may transmit the PUCCH transmission at the PUCCH transmission power determined in 618. Further, the UE may transmit the PUCCH on the resource determined in 604 in some embodiments. In some embodiments, 620 may be omitted.

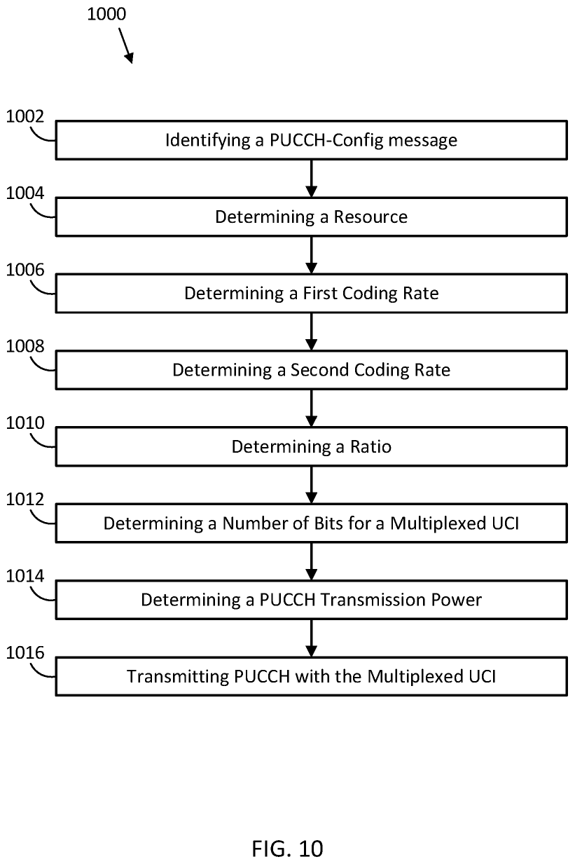

FIG. 10 illustrates an example procedure 1000 for transmitting a multiplexed UCI in accordance with some embodiments. A UE (such as the UE 102 (FIG. 1), the UE 202 (FIG. 2) and/or the UE 1200 (FIG. 12)) may perform the procedure 1000 for transmission of the multiplexed UCI. The procedure 1000 may apply the approaches described herein for determination of a PUCCH transmission power for the multiplexed UCI.

The procedure 1000 may include identifying a PUCCH-Config message in 1002. In particular, the UE may identify a PUCCH-Config message received from a base station (such as the base station 104 (FIG. 1), the base station 204 (FIG. 2), and/or the gNB 1300 (FIG. 13)). The PUCCH-Config message may indicate a first coding rate for a first UCI part of the multiplexed UCI and a second coding rate for a second UCI part of the multiplexed UCI. In some embodiments, 1002 may be omitted.

The procedure 1000 may further include determining a resource in 1004. In particular, the UE may determine the PUCCH resource for transmission of the multiplexed UCI on a PUCCH transmission. In some embodiments, the UE may receive a DCI from the base station that indicates the PUCCH resource for transmission of the multiplexed UCI. The UE may process the DCI and determine the PUCCH resource for transmission based on the DCI.

The procedure 1000 may further include determining a first coding rate in 1006. In particular, the UE may determine the first coding rate based on UCI elements within a first UCI part of the multiplexed UCI. For example, the UCI elements within the first UCI part may define the first coding rate in some embodiments. In some embodiments, the UE may determine the first coding rate based on the PUCCH-Config message identified in 1002. In particular, the UE may process the PUCCH-Config message and determine the first coding rate based on the indication of the first coding rate included in the PUCCH-Config message. In some embodiments, 1006 may be omitted.

The procedure 1000 may further include determining a second coding rate in 1008. In particular, the UE may determine the second coding rate based on UCI elements within a second UCI part of the multiplexed UCI. For example, the UCI elements within the second UCI part may define the second coding rate in some embodiments. In some embodiments, the first UCI part may include high priority UCI elements and the second UCI part may include low priority UCI elements. The different priority levels of the UCI elements may cause different coding rates in some embodiments. In some embodiments, the UE may determine the second coding rate based on the PUCCH-Config message identified in 1002. In particular, the UE may process the PUCCH-Config message and determine the second coding rate based on the indication of the second coding rate included in the PUCCH-Config message. In some embodiments, 1008 may be omitted.

The procedure 1000 may further include determining a ratio in 1010. In particular, the UE may determine a ratio of the first coding rate corresponding to the first UCI part of the multiplexed UCI to the second coding rate corresponding to the second UCI part of the multiplexed UCI. In some embodiments, the UE may determine the ratio based on the first coding rate determined in 1006 and the second coding rate determined in 1008.

The procedure 1000 may further include determining a number of composite UCI bits for the multiplexed UCI in 1012. For example, the UE may determine the number of the composite UCI bits in the multiplexed UCI. In some embodiments, the UE may determine whether the number of composite UCI bits is less than or equal to a certain number of bits or whether the number of composite UCI bits is greater than a certain number of bits. For example, the UE may determine whether the number of composite UCI bits is less than or equal to 11 bits or whether the number of composite UCI bits is greater than 11 bits in some embodiments. In some embodiments, the number of composite UCI bits may be determined based on

$$( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 2}^{total}} {O}_{UCI , n} + {O}_{CRC , UCI - part 1} ) ) ,$$

where N_{UCI-part1}^{total} is the total number of elements in the first UCI part, N_{UCI-part2}^{total} is the total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the first coding rate of the first UCI part, and r₂ is the second coding rate of the second UCI part. In some embodiments, 1012 may be omitted.

The procedure 1000 may further include determining a PUCCH transmission power in 1014. In particular, the UE may determine a PUCCH transmission power for transmission of the multiplexed UCI based on the ratio determined in 1010. In some embodiments, determining the PUCCH transmission power may include determining a PUCCH transmission power adjustment component based on the ratio. The UE may determine the PUCCH transmission power and/or the PUCCH transmission power adjustment component in accordance with the approaches described throughout this disclosure.

In some embodiments, the UE may further determine the PUCCH transmission power adjustment component based on the number of composite UCI bits for the multiplexed UCI determined in 1012. In particular, the UE may apply one calculation for determining the PUCCH transmission power adjustment component when the number of composite UCI bits of the multiplexed UCI is less than or equal to a certain number, and may apply another calculation for determining the PUCCH transmission power adjustment component when the number of composite UCI bits of the multiplexed UCI is greater than the certain number, as described further throughout this disclosure. In some embodiments, the UE may apply the first calculation for the number of composite UCI bits for the multiplexed UCI being less than or equal to 11 and the second calculation for the number of composite UCI bits of the multiplexed UCI being greater than 11. Further, the UE may apply the ratio to the bits for the multiplexed UCI and CRC bits of the multiplexed UCI when the number of bits is greater than 11, and may apply the ratio to bits for the multiplexed UCI when the number of bits is less than or equal to 11 in some embodiments. In some embodiments, the UE may apply the ratio to a bits for the first UCI part and avoid application of the ratio to the bits of the second UCI part, or vice versa, in some embodiments.

In some embodiments, the UE may determine the PUCCH transmission power adjustment component for a number of composite UCI bits of a multiplexed UCI produced via multiplexing of the first UCI part and the second UCI part being less than or equal to 11 based on

$${Δ}_{TF , b , f , c} ( i ) = 10 {log}_{10} ( {K}_{1} ( ( {\sum }_{n = 1}^{{N}_{UCI - part 2}^{total}} {O}_{U C I - part 2 , n} + {O}_{C R C , UCI - part 2} ) {r}_{1} / {r}_{2} + ( {\sum }_{n = 1}^{{N}_{UCI - part 1}^{total}} {O}_{U C I - p a r t 1 , n} + {O}_{C R C , U C I - p a r t 1} ) ) / {N}_{RE} ( i ) ) ,$$

where N_{UCI-part1}^{total} is a total number of elements in a first UCI part, N_{UCI-part2}^{total} is a total number of elements in a second UCI part, O_{UCI-part1,n} is a number of bits of the first UCI part, O_{UCI-part2,n} is a number of bits of the second UCI part, r₁ is the coding rate of the first UCI part, and r₂ is the coding rate of the second UCI part, and N_{RE}(i) is a number of resource elements. Further, the UE may determine the PUCCH transmission power adjustment component for a number of bits greater than 11 based on

$$BPRE ( i ) = ( ( {\sum }_{n = 1}^{{N}_{UCI - part 2}^{total}} {O}_{U C I - part 2 , n} + {O}_{C R C , UCI - part 2} ) {r}_{1} / {r}_{2} + ( {\sum }_{n = 1}^{{N}_{UCI - part 1}^{total}} {O}_{U C I - p a r t 1 , n} + {O}_{C R C , U C I - p a r t 1} ) ) / {N}_{RE ( i )} ,$$

where N_{UCI-part1}^{total} is a total number of elements in a first UCI part, N_{UCI-part2}^{total} is a total number of elements in a second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the coding rate of the first UCI part, r₂ is the coding rate of the second UCI part, and N_{RE}(i) is a number of resource elements.

In other embodiments, the UE may determine the PUCCH transmission power adjustment component in 1014 in accordance with the approaches discussed in relation to the tables 700 (FIG. 7), the table 800 (FIG. 8), or the table 900 (FIG. 9), as described further above in relation to the procedure 600 (FIG. 6).

The procedure 1000 may further include transmitting PUCCH with the multiplexed UCI in 1016. In particular, the UE may transmit a PUCCH transmission with the multiplexed UCI on the PUCCH resource determined in 1004 at the PUCCH transmission power determined in 1014. The UE may transmit the multiplexed UCI to the base station via the PUCCH transmission. The multiplexed UCI transmitted by the UE may be encoded in PUCCH format 2, PUCCH format 3, or PUCCH format 4.

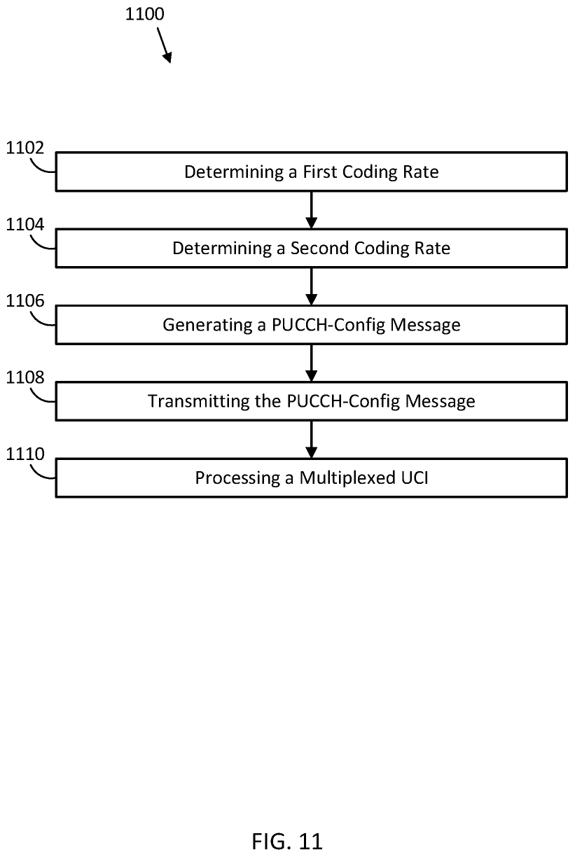

FIG. 11 illustrates an example procedure 1100 for providing transmission information for a multiplexed UCI in accordance with some embodiments. A base station (such as the base station 104 (FIG. 1), the base station 204 (FIG. 2) and/or the gNB 1300 (FIG. 13)) may perform the procedure 1100 to provide transmission information. The procedure 1100 may apply the approaches described herein for providing transmission information for a multiplexed UCI.

The procedure 1100 may include determining a first coding rate in 1102. In particular, the base station may determine a first coding rate for a first UCI part of the multiplexed UCI. In embodiments, the base station may determine the first coding rate based on UCI elements to be included in the first UCI part, or the base station may determine the first coding rate based on a predefined coding rate or a coding rate defined based on an operation of the RAN, or some portion thereof.

The procedure 1100 may further include determining a second coding rate in 1104. In particular, the base station may determine a second coding rate for a second UCI part of the multiplexed UCI. In embodiments, the base station may determine the second coding rate based on UCI elements to be included in the second UCI part, or the base station may determine the second coding rate based on a predefined coding rate or a coding rate defined based on an operation of the RAN, or some portion thereof.

The procedure 1100 may further include generating a PUCCH-Config message in 1106. In particular, the base station may generate the PUCCH-Config message that indicates the first coding rate for the first UCI part and the second coding rate for the second UCI part. For example, the PUCCH-Config message may indicate the first coding rate determined in 1102 and the second coding rate determined in 1104. In some embodiments, the PUCCH-Config message may be a high priority PUCCH-Config message.

The procedure 1100 may include transmitting the PUCCH-Config message in 1108. In particular, the base station may transmit the PUCCH-Config message to the UE. The PUCCH-Config message may indicate to the UE that the UE is to utilize the first coding rate and the second coding rate indicated in the PUCCH-Config message to determine a PUCCH transmission power for the multiplexed UCI.

The procedure 1100 may further include processing the multiplexed UCI in 1110. In particular, the base station may process the multiplexed UCI received from a UE (such as the UE 102 (FIG. 1), the UE 202 (FIG. 2) and/or the UE 1200 (FIG. 12)) as part of a PUCCH transmission. The PUCCH transmission may be transmitted by the UE at a PUCCH transmission power determined based on the first coding rate and the second coding rate indicated in the PUCCH-Config message. The base station may process the multiplexed UCI to obtain the UCI elements included in the multiplexed UCI.

The following presents further information regarding how the approaches described within this disclosure may be utilized within a WAN. For example, the following may be included in a technical specification for a WAN. It should be understood that the following is an example of what may be included in a technical specification and that various changes may be made when the text is implemented.

If the user equipment (UE) is configured with a secondary cell group (SCG), the UE may apply the procedures described in this clause for both master cell group (MCG) and SCG.
When the procedures are applied for MCG, the term ‘serving cell’ in this clause refers to serving cell belonging to the MCG.
When the procedures are applied for SCG, the term ‘serving cell’ in this clause refers to serving cell belonging to the SCG. The term ‘primary cell’ in this clause refers to the PSCell of the SCG.

If the UE is configured with a PUCCH-secondary cell (SCell), the UE may apply the procedures described in this clause for both primary PUCCH group and secondary PUCCH group.
When the procedures are applied for the primary PUCCH group, the term ‘serving cell’ in this clause refers to serving cell belonging to the primary PUCCH group.
When the procedures are applied for the secondary PUCCH group, the term ‘serving cell’ in this clause refers to serving cell belonging to the secondary PUCCH group. The term ‘primary cell’ in this clause refers to the PUCCH-SCell of the secondary PUCCH group. If pdsch-HARQ-ACK-Codebook-secondaryPUCCHgroup-r16 is provided, pdsch-HARQ-ACK-Codebook is replaced by pdsch-HARQ-ACK-Codebook-secondaryPUCCHgroup-r16.

7.2.1 UE Behaviour

If a UE transmits a PUCCH on active uplink (UL) bandwidth part (BWP) b of carrier f in the primary cell c using PUCCH power control adjustment state with index l, the UE determines the PUCCH transmission power P_{PUCCH,b,f,c}(i,qᵤ,q_{d},l) in PUCCH transmission occasion i as

$${P}_{PUCCH , b , f , c} ( i , {q}_{u} , {q}_{d} , l ) = min \{ \begin{matrix}{P}_{C MAX , f , c} ( i ) , \\ {P}_{{O}_{PUCCH , b , f , c}} ( {q}_{u} ) + 10 {log}_{10} ( {2}^{μ} \cdot {M}_{RB , b , f , c}^{PUCCH} ( i ) ) + P {L}_{b , f , c} ( {q}_{d} ) + {Δ}_{F\_PUCCH} ( F ) + {Δ}_{TF , b , f , c} ( i ) + {g}_{b , f , c} ( i , l )\end{matrix} [ decibel milliwatts ( dBm ) ]$$

where
P_{CMAX,f,c}(i) is the UE configured maximum output power defined in [8-1, TS 38.101-1], [8-2, TS38.101-2] and [8-3, TS38.101-3] (3GPP Organizational Partners. (2021-06). 3rd Generation Partnership Project; Technical Specification Group Radio Access Network; NR; User Equipment (UE) radio transmission and reception; Part 1: Range 1 Standalone (Release 17)) (3GPP TS 38.101-1 V17.2.0)) for carrier f of primary cell c in PUCCH transmission occasion i
P_{O_PUCCH,b,f,c}(qᵤ) is a parameter composed of the sum of a component P_{O_NOMINAL_PUCCH}, provided by p0-nominal, or

$${P}_{{O}_{N O M I N A {L}_{PUCCH}}} = 0 dBm$$

if p0-nominal is not provided, for carrier f of primary cell c and, if provided, a component P_{O_UE_PUCCH}(qᵤ) provided by p0-PUCCH-Value in P0-PUCCH for active UL BWP b of carrier f of primary cell c, where 0≤qᵤ<Qᵤ. Qᵤ is a size for a set of P_{O_UE_PUCCH} values provided by maxNrofPUCCH-P0-PerSet. The set of P_{O_UE_PUCCH} values may be provided by p0-Set. If p0-Set is not provided to the UE,

$${P}_{{O}_{{UE}_{PUCCH}}} ( {q}_{u} ) = 0 , 0 \leq {q}_{u} < {Q}_{u}$$

If the UE is provided PUCCH-SpatialRelationInfo, the UE may obtain a mapping, by an index provided by p0-PUCCH-Id, between a set of pucch-SpatialRelationInfoId values and a set of p0-PUCCH-Value values. If the UE is provided more than one values for pucch-SpatialRelationInfoId and the UE receives an activation command [11, TS 38.321] indicating a value of pucch-SpatialRelationInfoId, the UE may determine the p0-PUCCH-Value value through the link to a corresponding p0-PUCCH-Id index. The UE may apply the activation command in the first slot that is after slot k+3·Nₛₗₒₜ^{subframe,μ} where k is the slot where the UE may transmit a PUCCH with HARQ-ACK information for the physical downlink shared channel (PDSCH) providing the activation command and μ is the subcarrier spacing (SCS) configuration for the PUCCH
If the UE is not provided PUCCH-SpatialRelationInfo, the UE obtains the p0-PUCCH-Value value from the P0-PUCCH with p0-PUCCH-Id value equal to the minimum p0-PUCCH-Id value in p0-Set
M_{RB,b,f,c}^{PUCCH} (i) is a bandwidth of the PUCCH resource assignment expressed in number of resource blocks for PUCCH transmission occasion i on active UL BWP b of carrier f of primary cell c and μ is a SCS configuration defined in [4, TS 38.211]
PL_{b,f,c}(q_{d}) is a downlink pathloss estimate in dB calculated by the UE using reference signal (RS) resource index q_{d} as described in Clause 7.1.1 for the active downlink (DL) BWP b of carrier f of the primary cell c as described in Clause 12
If the UE is not provided pathlossReferenceRSs or before the UE is provided dedicated higher layer parameters, the UE may calculate PL_{b,f,c}(q_{d}) using a RS resource obtained from an synchronization signal (SS)/physical broadcast channel (PBCH) block with same SS/PBCH block index as the one the UE uses to obtain MIB
If the UE is provided a number of RS resource indexes, the UE may calculate PL_{b,f,c}(q_{d}) using RS resource with index q_{d}, where 0≤q_{d}<Q_{d}. Q_{d} is a size for a set of RS resources provided by maxNrofPUCCH-PathlossReferenceRSs. The set of RS resources may be provided by pathlossReferenceRSs. The set of RS resources can include one or both of a set of SS/PBCH block indexes, each provided by ssb-Index in PUCCH-PathlossReferenceRS when a value of a corresponding pucch-PathlossReferenceRS-Id maps to a SS/PBCH block index, and a set of channel state information reference signal (CSI-RS) resource indexes, each may be provided by csi-RS-Index when a value of a corresponding pucch-PathlossReferenceRS-Id maps to a CSI-RS resource index. The UE may identify a RS resource in the set of RS resources to correspond either to a SS/PBCH block index or to a CSI-RS resource index as provided by pucch-PathlossReferenceRS-Id in PUCCH-PathlossReferenceRS
If the UE is provided pathlossReferenceRSs and PUCCH-SpatialRelationInfo, the UE may obtain a mapping, by indexes provided by corresponding values of pucch-PathlossReferenceRS-Id, between a set of pucch-SpatialRelationInfoId values and a set of referenceSignal values provided by PUCCH-PathlossReferenceRS. If the UE is provided more than one values for pucch-SpatialRelationInfoId and the UE receives an activation command [11, TS 38.321] indicating a value of pucch-SpatialRelationInfoId, the UE may determine the referenceSignal value in PUCCH-PathlossReferenceRS through the link to a corresponding pucch-PathlossReferenceRS-Id index. The UE may apply the activation command in the first slot that is after slot k+3 N slot subframe,μ where k is the slot where the UE may transmit a PUCCH with HARQ-ACK information for the physical downlink shared channel (PDSCH) providing the activation command and μ is the SCS configuration for the PUCCH
If PUCCH-SpatialRelationInfo includes servingCellId indicating a serving cell, the UE may receive the RS for resource index q_{d} on the active DL BWP of the serving cell
If the UE is provided pathlossReferenceRSs and is not provided PUCCH-SpatialRelationInfo, the UE may obtain the referenceSignal value in PUCCH-PathlossReferenceRS from the pucch-PathlossReferenceRS-Id with index 0 in PUCCH-PathlossReferenceRS where the RS resource is either on the primary cell or, if provided, on a serving cell indicated by a value of pathlossReferenceLinking
If the UE
is not provided pathlossReferenceRSs, and
is not provided PUCCH-SpatialRelationInfo, and
is provided enableDefaultBeamPL-ForPUCCH, and
is not provided coresetPoolIndex value of 1 for any control resource set (CORESET), or is provided coresetPoolIndex value of 1 for all CORESETs, in ControlResourceSet and no codepoint of a transmission configuration indicator (TCI) field, if any, in a DCI format of any search space set maps to two TCI states [5, TS 38.212]
the UE may determine a RS resource index q_{d} providing a periodic RS resource configured with qcl-Type set to ‘typeD’ in the TCI state or the QCL assumption of a CORESET with the lowest index in the active DL BWP of the primary cell. For a PUCCH transmission over multiple slots, a same q_{d} may apply to the PUCCH transmission in each of the multiple slots.
The parameter Δ_{F_PUCCH}(F) is a value of deltaF-PUCCH-f0 for PUCCH format 0, deltaF-PUCCH-f1 for PUCCH format 1, deltaF-PUCCH-f2 for PUCCH format 2, deltaF-PUCCH-f3 for PUCCH format 3, and deltaF-PUCCH-f4 for PUCCH format 4, if provided; otherwise Δ_{F_PUCCH}(F)=0.
Δ_{TF,b,f,c}(i) is a PUCCH transmission power adjustment component on active UL BWP b of carrier f of primary cell c
For a PUCCH transmission using PUCCH format 0 or PUCCH format 1,

$${Δ}_{TF , b , f , c} ( i ) = 10 {log}_{10} ( \frac{{N}_{ref}^{PUCCH}}{{N}_{symb}^{PUCCH} ( i )} ) + {Δ}_{U C I} ( i )$$

where
N_{symb}^{PUCCH}(i) is a number of PUCCH format 0 symbols or PUCCH format 1 symbols for the PUCCH transmission as described in Clause 9.2.
N_{ref}^{PUCCH}=2 for PUCCH format 0
N_{ref}^{PUCCH}=N_{symb}^{slot} for PUCCH format 1
Δ_{UCI}(i)=0 for PUCCH format 0
Δ_{UCI}(i)=10 log₁₀ (O_{UCI}(i)) for PUCCH format 1, where O_{UCI}(i) is a number of UCI bits in PUCCH transmission occasion i
For a PUCCH transmission using PUCCH format 2 or PUCCH format 3 or PUCCH format 4 and for a number of UCI bits smaller than or equal to 11,

$${Δ}_{T F , b , f , c} ( i ) = 10 {log}_{10} ( {K}_{1} \cdot ( ( {\sum }_{n = 1}^{{N}_{UCI - part 2}^{total}} {O}_{U C I - p a r t 2 , n} + {O}_{C R C , UCI - part 2} ) {r}_{1} / {r}_{2} + ( {\sum }_{n = 1}^{{N}_{UCI - part 1}^{total}} {O}_{UCI - part 1 , n} + {O}_{C R C , UCI - part 1} ) ) / {N}_{R E} ( i ) ) ,$$

where
N_{UCI-part1}^{total} is a total number of elements in a first UCI part
N_{UCI-part2}^{total} is a total number of elements in a second UCI part
O_{UCI-part1,n} is a number of bits of the first UCI part excluding cyclic redundancy check (CRC) bits
O_{CRC,UCI-part1} is a number of bits of the CRC in the first UCI part
O_{UCI-part2,n} is a number of bits of the second UCI part excluding CRC bits
O_{CRC,UCI-part2} is a number of bits of the CRC in the second UCI part
r₁ is the coding rate of the first UCI part
r₂ is the coding rate of the second UCI part
K₁=6
N_{RE}(i) is a number of resource elements determined as N_{RE}(i)=M_{RBb,f,c}^{PUCCH}(i)·N_{sc,ctrl}^{RB}(i)·N_{symb-UCI,b,f,c}^{PUCCH}, where N_{sc,ctrl}^{RB}(i) is a number of subcarriers per resource block excluding subcarriers used for demodulation reference signal (DM-RS) transmission, and N_{symb-UCI,b,f,c}^{PUCCH} is a number of symbols excluding symbols used for DM-RS transmission, as defined in Clause 9.2.5.2, for PUCCH transmission occasion i on active UL BWP b of carrier f of primary cell c
For a PUCCH transmission using PUCCH format 2 or PUCCH format 3 or PUCCH format 4 and for a number of UCI bits larger than 11, Δ_{TF,b,f,c}(i)=10 log₁₀(2^{K}^{₂}^{·BPRE(i)}−1), where
K₂=2.4

$$BPRE ( i ) = ( ( {\sum }_{n = 1}^{{N}_{UCI - part 2}^{total}} {O}_{U C I - part 2 , n} + {O}_{C R C , UCI - part 2} ) {r}_{1} / {r}_{2} + ( {\sum }_{n = 1}^{{N}_{UCI - part 1}^{total}} {O}_{U C I - p a r t 1 , n} + {O}_{C R C , U C I - p a r t 1} ) ) / {N}_{RE ( i )}$$

N_{UCI-part1}^{total} is a total number of elements in a first UCI part
N_{UCI-part2}^{total} is a total number of elements in a second UCI part
O_{UCI-part1,n} is a number of bits of the first UCI part excluding cyclic redundancy check (CRC) bits bits
O_{CRC,UCI-part1} is a number of bits of the CRC in the first UCI part
O_{UCI-part2,n} is a number of bits of the second UCI part excluding CRC
O_{CRC,UCI-part2} is a number of bits of the CRC in the second UCI part
r₁ is the coding rate of the first UCI part
r₂ is the coding rate of the second UCI part
N_{RE}(i) is a number of resource elements that the UE determines as N_{RE}(i)=M_{RBb,f,c}^{PUCCH}(i)·N_{sc,ctrl}^{RB}(i)·N_{symb-UCI,b,f,c}^{PUCCH}(i), where N_{sc,ctrl}^{RB}(i) is a number of subcarriers per resource block excluding subcarriers used for DM-RS transmission, and N_{symb-UCI,b,f,c}^{PUCCH}(i) is a number of symbols excluding symbols used for DM-RS transmission, as defined in Clause 9.2.5.2, for PUCCH transmission occasion i on active UL BWP b of carrier f of primary cell c.
For the PUCCH power control adjustment state g_{b,f,c}(i,l) for active UL BWP b of carrier f of primary cell c and PUCCH transmission occasion i
δ_{PUCCH,b,f,c}(i,l) is a transmit power control (TPC) command value included in a downlink control information (DCI) format scheduling a PDSCH reception for active UL BWP b of carrier f of the primary cell c that the UE detects for PUCCH transmission occasion i, or is jointly coded with other TPC commands in a DCI format 2_2 with CRC scrambled by TPC-PUCCH-RNTI [5, TS 36.212], as described in Clause 11.3
l∈{0,1} if the UE is provided twoPUCCH-PC-AdjustmentStates and PUCCH-SpatialRelationInfo and 1=0 if the UE is not provided twoPUCCH-PC-AdjustmentStates or PUCCH-SpatialRelationInfo
If the UE obtains a TPC command value from a DCI format scheduling a PDSCH reception and if the UE is provided PUCCH-SpatialRelationInfo, the UE may obtain a mapping, by an index provided by p0-PUCCH-Id, between a set of pucch-SpatialRelationInfoId values and a set of values for closedLoopIndex that provide the 1 value(s). If the UE receives an activation command indicating a value of pucch-SpatialRelationInfoId, the UE may determine the value closedLoopIndex that provides the value of 1 through the link to a corresponding p0-PUCCH-Id index
If the UE obtains one TPC command from a DCI format 2_2 with CRC scrambled by a TPC-PUCCH-RNTI, the l value may be provided by the closed loop indicator field in DCI format 2_2
g_{b,f,c}(i,l)=g_{b,f,c}(i−i₀,l)+Σₘ₌₀^{C(C}^{ᵢ}⁾⁻¹δ_{PUCCH,b,f,c}(m,l) is the current PUCCH power control adjustment state l for active UL BWP b of carrier f of primary cell c and PUCCH transmission occasion i, where

The δ_{PUCCH,b,f,c} values are given in Table 7.1.2-1
Σₘ₌₀^{C(C}^{ᵢ}⁾⁻¹δ_{PUCCH,b,f,c}(m,l) is a sum of TPC command values in a set Cᵢ of TPC command values with cardinality C(Cᵢ) that the UE receives between K_{PUCCH}(i−i₀)−1 symbols before PUCCH transmission occasion i−i₀ and K_{PUCCH}(i) symbols before PUCCH transmission occasion i on active UL BWP b of carrier f of primary cell c for PUCCH power control adjustment state, where i₀>0 is the smallest integer for which K_{PUCCH}(i−i₀) symbols before PUCCH transmission occasion i−i₀ is earlier than K_{PUCCH}(i) symbols before PUCCH transmission occasion i
If the PUCCH transmission is in response to a detection by the UE of a DCI format, K_{PUCCH}(i) is a number of symbols for active UL BWP b of carrier f of primary cell c after a last symbol of a corresponding PDCCH reception and before a first symbol of the PUCCH transmission
If the PUCCH transmission is not in response to a detection by the UE of a DCI format, K_{PUCCH}(i) is a number of K_{PUCCH,min} symbols equal to the product of a number of symbols per slot, N_{symb}^{slot}, and the minimum of the values provided by k2 in PUSCH-ConfigCommon for active UL BWP b of carrier f of primary cell c
If the UE has reached maximum power for active UL BWP b of carrier f of primary cell c at PUCCH transmission occasion i−i₀ and Σₘ₌₀^{C(C}^{ᵢ}⁾⁻¹ δ_{PUCCH,b,f,c}(m,l)≥0, then g_{b,f,c}(i,l)=g_{b,f,c}(i−i₀,l)
If UE has reached minimum power for active UL BWP b of carrier f of primary cell c at PUCCH transmission occasion i−i₀ and Σₘ₌₀^{C(C}^{ᵢ}⁾⁻¹δ_{PUCCH,b,f,c}(m,l)≤0, then g_{b,f,c}(i,l)=g_{b,f,c}(i−i₀,l)
If a configuration of a P_{O_PUCCH,b,f,c}(qᵤ) value for a corresponding PUCCH power control adjustment state l for active UL BWP b of carrier f of primary cell c is provided by higher layers,
g_{b,f,c}(k,l)=0,k=0, 1, . . . , i
If the UE is provided PUCCH-SpatialRelationInfo, the UE determines the value of l from the value of qᵤ based on a pucch-SpatialRelationInfoId value associated with the p0-PUCCH-Id value corresponding to qᵤ and with the closedLoopIndex value corresponding to l; otherwise, 1=0
Else,
g_{b,f,c}(0,l)=ΔP_{rampup,b,f,c}+δ_{b,f,c}, where l=0, and δ_{b,f,c} is
the TPC command value indicated in a random access response grant corresponding to a physical random access channel (PRACH) transmission according to Type-1 random access procedure, or in a random access response grant corresponding to MsgA transmissions according to Type-2 random access procedure with random access response (RAR) message(s) for fallbackRAR, or
the TPC command value indicated in a successRAR corresponding to MsgA transmissions for Type-2 random access procedure, or
the TPC command value in a DCI format with CRC scrambled by cell radio network temporary identifier (C-RNTI) or modulation coding scheme cell radio network temporary identifier (MCS-C-RNTI) that the UE detects in a first PDCCH reception in a search space set provided by recoverySearchSpaceId if the PUCCH transmission is a first PUCCH transmission after 28 symbols from a last symbol of the first PDCCH reception,

and, if the UE transmits PUCCH on active UL BWP b of carrier f of primary cell c,

$$Δ {P}_{ramp up , b , f , c} = min [ \begin{matrix}max ( \begin{matrix}0 , \\ {P}_{C MAX , f , {c}^{-}} ( {P}_{O\_PUCCH , b , f , c} + {PL}_{b , f , c} ( {q}_{d} ) + {Δ}_{{F}_{PUCCH}} ( F ) + {Δ}_{TF , b , f , c} + {δ}_{b , f , c} )\end{matrix} ) \\ Δ {P}_{ramp up requested , b , f , c}\end{matrix} ] ;$$

$$otherwise ,$$

$$Δ {P}_{ramp up , b , f , c} = min [ \begin{matrix}max ( \begin{matrix}0 , \\ {P}_{C MAX , f , {c}^{-}} ( {P}_{O\_PUCCH , b , f , c} + {PL}_{b , f , c} ( {q}_{d} ) )\end{matrix} ) \\ Δ {P}_{ramp up requested , b , f , c}\end{matrix} ]$$

where ΔP_{rampuprequested,b,f,c} is provided by higher layers and corresponds to the total power ramp-up requested by higher layers from the first to the last preamble for active UL BWP b of carrier f of primary cell c, and Δ_{F_PUCCH}(F) corresponds to PUCCH format 0 or PUCCH format 1

FIG. 12 illustrates an example UE 1200 in accordance with some embodiments. The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1200 may be a RedCap UE or NR-Light UE.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, optical connection, etc. that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1208 may include transceiver circuitry and radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, phased array antennas, etc. The antenna 1226 may have one or more panels designed for specific frequency bands including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1200 may power down for brief intervals of time and thus save power. If there is no data traffic activity for an extended period of time, then the UE 1200 may transition off to an RRC_Idle state, where it disconnects from the network and does not perform operations such as channel quality feedback, handover, etc. The UE 1200 goes into a very low power state and it performs paging where again it periodically wakes up to listen to the network and then powers down again. The UE 1200 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

FIG. 13 illustrates an example gNB 1300 in accordance with some embodiments. The gNB 1300 may include processors 1304, RF interface circuitry 1308, core network (CN) interface circuitry 1312, memory/storage circuitry 1316, and antenna structure 1326.

The components of the gNB 1300 may be coupled with various other components over one or more interconnects 1328.

The processors 1304, RF interface circuitry 1308, memory/storage circuitry 1316 (including communication protocol stack 1310), antenna structure 1326, and interconnects 1328 may be similar to like-named elements shown and described with respect to FIG. 12.

The CN interface circuitry 1312 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method for determining a physical uplink control channel (PUCCH) transmission power, comprising determining, by a user equipment (UE), a first coding rate for first uplink control information (UCI) part to be multiplexed in a PUCCH transmission, determining, by the UE, a second coding rate for a second UCI part to be multiplexed in the PUCCH transmission, determining, by the UE, a ratio of the first coding rate to the second coding rate, determining, by the UE, a power adjustment component based on the ratio, and determining, by the UE, the PUCCH transmission power based on the power adjustment component.

Example 2 may include the method of example 1, wherein the first UCI part includes UCI elements having a first priority, and wherein the second UCI part includes UCI elements having a second priority that is less than the first priority.

Example 3 may include the method of example 1, further comprising determining a number of composite UCI bits for a multiplexed UCI, the multiplexed UCI produced via multiplexing of the first UCI part and the second UCI part, wherein the power adjustment component is determined further based on the number of composite UCI bits.

Example 4 may include the method of example 3, further comprising determining the number of composite UCI bits based on

$$( ( {\sum }_{n = 1}^{{N}_{UCI - part 2}^{total}} {O}_{U C I - part 2 , n} + {O}_{C R C , UCI - part 2} ) {r}_{1} / {r}_{2} + ( {\sum }_{n = 1}^{{N}_{UCI - part 1}^{total}} {O}_{U C I - p a r t 1 , n} + {O}_{C R C , U C I - p a r t 1} ) ) ,$$

where N_{UCI-part1}^{total} is the total number of elements in the first UCI part, N_{UCI-part2}^{total} is the total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the first coding rate of the first UCI part, and r₂ is the second coding rate of the second UCI part.

Example 5 may include the method of example 1, wherein a PUCCH transmission for transmission on the PUCCH transmission produced via multiplexing of the first UCI part and the second UCI part is of a PUCCH format 2, a PUCCH format 3, or a PUCCH format 4.

Example 6 may include the method of example 1, wherein determining the power adjustment component comprises for a number of bits of a multiplexed UCI produced via multiplexing of the first UCI part and the second UCI part being less than or equal to 11, determining the power adjustment component based on

$${Δ}_{T F , b , f , c} ( i ) = 10 {log}_{10} ( {K}_{1} ( ( {\sum }_{n = 1}^{{N}_{UCI - part 2}^{t o t a 1}} {O}_{U C I - p a r t 2 , n} + {O}_{C R C , UCI - part 2} ) {r}_{1} / {r}_{2} + ( {\sum }_{n = 1}^{{N}_{UCI - part 1}^{total}} {O}_{UCI - part 1 , n} ) ) / {N}_{R E} ( i ) ) ,$$

where K₁ is 6, N_{UCI-part1}^{total} is a total number of elements in the first UCI part, N_{UCI-part2}^{total} is a total number of elements in the second UCI part, O_{UCI-part1,n} is a number of bits of the first UCI part, O_{UCI-part2,n} is a number of bits of the second UCI part, O_{CRC,UCI-part2} is a number of bits of the CRC in the second UCI part, r₁ is the first coding rate of the first UCI part, and r₂ is the second coding rate of the second UCI part, and N_{RE}(i) is a number of resource elements, and for a number of bits greater than 11, determining the power adjustment component based on

$$BPRE ( i ) = ( ( {\sum }_{n = 1}^{{N}_{UCI - part 2}^{total}} {O}_{U C I - part 2 , n} + {O}_{C R C , UCI - part 2} ) {r}_{1} / {r}_{2} + ( {\sum }_{n = 1}^{{N}_{UCI - part 1}^{total}} {O}_{U C I - p a r t 1 , n} + {O}_{UCI - part 1 , n} + {O}_{C R C , UCI - part 1} ) ) / {N}_{RE ( i )} ,$$

where N_{UCI-part1}^{total} is the total number of elements in the first UCI part, N_{UCI-part2}^{total} is the total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the first coding rate of the first UCI part, r₂ is the second coding rate of the second UCI part, and N_{RE}(i) is the number of resource elements.

Example 7 may include the method of example 1, further comprising identifying a PUCCH-Config message received from a base station, wherein the PUCCH-Config message indicates the first coding rate and the second coding rate.

Example 8 may include the method of example 1, further comprising multiplexing the first UCI part and the second UCI part to produce a multiplexed UCI, determining a PUCCH resource for transmission of the multiplexed UCI based on downlink control information (DCI) received from a base station, and transmitting the multiplexed UCI on the PUCCH resource at the PUCCH transmission power.

Example 9 may include a method for transmitting multiplexed uplink control information (UCI), comprising determining, by a user equipment (UE), a ratio of a first coding rate corresponding to a first UCI part of the multiplexed UCI to a second coding rate corresponding to a second UCI part of the multiplexed UCI, determining, by the UE, a physical uplink control channel (PUCCH) transmission power for transmission of the multiplexed UCI based on the ratio, determining, by the UE, a PUCCH resource for transmission of the multiplexed UCI on a PUCCH transmission, and transmitting, by the UE, the multiplexed UCI on the PUCCH resource at the PUCCH transmission power.

Example 10 may include the method of example 9, wherein determining the PUCCH transmission power includes determining a power adjustment component based on the ratio.

Example 11 may include the method of example 10, further comprising determining a number of bits for the multiplexed UCI, wherein the power adjustment component is further based on the number of bits for the multiplexed UCI.

Example 12 may include the method of example 11, further comprising determining the number of composite UCI bits with

$$( ( {\sum }_{n = 1}^{{N}_{UCI - part 2}^{total}} {O}_{U C I - part 2 , n} + {O}_{C R C , UCI - part 2} ) {r}_{1} / {r}_{2} + ( {\sum }_{n = 1}^{{N}_{UCI - part 1}^{total}} {O}_{U C I - p a r t 1 , n} + {O}_{C R C , UCI - part 1} ) ) ,$$

where N_{UCI-part1}^{total} is the total number of elements in the first UCI part, N_{UCI-part2}^{total} is the total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the first coding rate of the first UCI part, and r₂ is the second coding rate of the second UCI part.

Example 13 may include the method of example 9, wherein the first UCI part includes UCI elements having a first priority, and wherein the second UCI part includes UCI elements having a second priority that is less than the first priority.

Example 14 may include the method of example 9, wherein the multiplexed UCI is transmitted on the PUCCH transmission in PUCCH format 2, PUCCH format 3, or PUCCH format 4.

Example 15 may include the method of example 9, further comprising identifying a PUCCH-Config message that indicates the first coding rate and the second coding rate received from a base station.

Example 16 may include the method of example 9, wherein the resource set for transmission is determined based on downlink control information (DCI) received from a base station.

Example 17 may include the method of example 9, further comprising determining the first coding rate based on UCI elements within the first UCI part, and determining the second coding rate based on UCI elements within the second UCI part.

Example 18 may include a method for indicating coding rates for parts of multiplexed uplink control information (UCI), comprising determining, by a base station, a first coding rate for a first UCI part of the multiplexed UCI, determining, by the base station, a second coding rate for a second UCI part of the multiplexed UCI, generating, by the base station, a physical uplink control channel (PUCCH)-Config message that indicates the first coding rate for the first UCI part and the second coding rate for the second UCI part, and transmitting, by the base station, the PUCCH-Config message to a user equipment (UE) that is to utilize the first coding rate and the second coding rate to determine a PUCCH transmission power for the multiplexed UCI.

Example 19 may include the method of example 18, wherein the PUCCH-Config message comprises a high priority PUCCH-Config message.

Example 20 may include the method of example 18, further comprising processing the multiplexed UCI received from the UE in a PUCCH transmission, wherein the PUCCH transmission is transmitted at a PUCCH transmission power determined based on the first coding rate and the second coding rate.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. One or more non-transitory computer-readable media having instructions stored thereon, wherein the instructions, when executed by a user equipment (UE) cause the UE to:
determine a first coding rate for first uplink control information (UCI) part to be multiplexed in a physical uplink control channel (PUCCH) transmission;
determining, by the UE, a second coding rate for a second UCI part to be multiplexed in the PUCCH transmission;
determine a ratio of the first coding rate to the second coding rate;
determine a power adjustment component based on the ratio; and
determine a PUCCH transmission power based on the power adjustment component.

2. The one or more non-transitory computer-readable media of claim 1, wherein the first UCI part includes UCI elements having a first priority, and wherein the second UCI part includes UCI elements having a second priority that is less than the first priority.

3. The one or more non-transitory computer-readable media of claim 1, wherein the instructions, when executed by the UE, further cause the UE to determine a number of composite UCI bits for a multiplexed UCI, the multiplexed UCI produced via multiplexing of the first UCI part and the second UCI part, wherein the power adjustment component is determined further based on the number of composite UCI bits.

4. The one or more non-transitory computer-readable media of claim 3, wherein the instructions, when executed by the UE, further cause the UE to determine the number of composite UCI bits based on
$$( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) ,$$
where N_{UCI-part1}^{total} is a total number of elements in the first UCI part, N_{UCI-part2}^{total} is a total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the first coding rate of the first UCI part, and r₂ is the second coding rate of the second UCI part.

5. The one or more non-transitory computer-readable media of claim 1, wherein a PUCCH transmission for transmission on the PUCCH transmission produced via multiplexing of the first UCI part and the second UCI part is of a PUCCH format 2, a PUCCH format 3, or a PUCCH format 4.

6. The one or more non-transitory computer-readable media of claim 1, wherein to determine the power adjustment component comprises to:
for a number of bits of a multiplexed UCI produced via multiplexing of the first UCI part and the second UCI part being less than or equal to 11, determine the power adjustment component based on
$${Δ}_{TF , b , f , c} ( i ) = 10 {log}_{10} ( {K}_{1} ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} ) ) / {N}_{RE} ( i ) ) ,$$
where K₁ is 6, N_{UCI-part1}^{total} is a total number of elements in the first UCI part, N_{UCI-part2}^{total} is a total number of elements in the second UCI part, O_{UCI-part1,n} is a number of bits of the first UCI part, O_{UCI-part2,n} is a number of bits of the second UCI part, O_{CRC,UCI-part2} is a number of bits of a cyclic redundancy check (CRC) in the second UCI part, r₁ is the first coding rate of the first UCI part, and r₂ is the second coding rate of the second UCI part, and N_{RE}(i) is a number of resource elements; and
for a number of bits greater than 11, determine the power adjustment component based on
$$BPRE ( i ) = ( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) / {N}_{RE} ( i ) ,$$
where N_{UCI-part1}^{total} is the total number of elements in the first UCI part, N_{UCI-part2}^{total} is the total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is the number of bits of the CRC in the second UCI part, r₁ is the first coding rate of the first UCI part, r₂ is the second coding rate of the second UCI part, and N_{RE}(i) is the number of resource elements.

7. The one or more non-transitory computer-readable media of claim 1, wherein the instructions, when executed by the UE, further cause the UE to identify a PUCCH-Config message received from a base station, wherein the PUCCH-Config message indicates the first coding rate and the second coding rate.

8. The one or more non-transitory computer-readable media of claim 1, wherein the instructions, when executed by the UE, further cause the UE to:
multiplex the first UCI part and the second UCI part to produce a multiplexed UCI;
determine a PUCCH resource for transmission of the multiplexed UCI based on downlink control information (DCI) received from a base station; and
transmit the multiplexed UCI on the PUCCH resource at the PUCCH transmission power.

9. A method for transmitting multiplexed uplink control information (UCI), comprising:
determining, by a user equipment (UE), a ratio of a first coding rate corresponding to a first UCI part of the multiplexed UCI to a second coding rate corresponding to a second UCI part of the multiplexed UCI;
determining, by the UE, a physical uplink control channel (PUCCH) transmission power for transmission of the multiplexed UCI based on the ratio;
determining, by the UE, a PUCCH resource for transmission of the multiplexed UCI on a PUCCH transmission; and
transmitting, by the UE, the multiplexed UCI on the PUCCH resource at the PUCCH transmission power.

10. The method of claim 9, wherein determining the PUCCH transmission power includes determining a power adjustment component based on the ratio.

11. The method of claim 10, further comprising determining a number of bits for the multiplexed UCI, wherein the power adjustment component is further based on the number of bits for the multiplexed UCI.

12. The method of claim 11, further comprising determining a number of composite UCI bits with
$$( ( {\sum }_{n = 1}^{{N}_{UCI - part 2}^{total}} {O}_{UCI - part 2 , n} + {O}_{CRC , UCI - part 2} ) {r}_{1} / {r}_{2} + ( {\sum }_{n = 1}^{{N}_{UCI - part 1}^{total}} {O}_{UCI - part 1 , n} + {O}_{CRC , UCI - part 1} ) ) ,$$
where N_{UCI-part1}^{total} is a total number of elements in the first UCI part, N_{UCI-part2}^{total} is a total number of elements in the second UCI part, O_{UCI-part1,n} is a number of bits of the first UCI part excluding cyclic redundancy check (CRC) bits, O_{CRC,UCI-part1} is a number of bits of the CRC in the first UCI part, O_{UCI-part2,n} is a number of bits of the second UCI part excluding CRC bits, O_{CRC,UCI-part2} is a number of bits of the CRC in the second UCI part, r₁ is the first coding rate of the first UCI part, and r₂ is the second coding rate of the second UCI part.

13. The method of claim 9, wherein the first UCI part includes UCI elements having a first priority, and wherein the second UCI part includes UCI elements having a second priority that is less than the first priority.

14. The method of claim 9, wherein the multiplexed UCI is transmitted on the PUCCH transmission in PUCCH format 2, PUCCH format 3, or PUCCH format 4.

15. The method of claim 9, further comprising identifying a PUCCH-Config message that indicates the first coding rate and the second coding rate received from a base station.

16. The method of claim 9, wherein a resource set for transmission is determined based on downlink control information (DCI) received from a base station.

17. The method of claim 9, further comprising:
determining the first coding rate based on UCI elements within the first UCI part; and
determining the second coding rate based on UCI elements within the second UCI part.

18. A method for indicating coding rates for parts of multiplexed uplink control information (UCI), comprising:
determining, by a base station, a first coding rate for a first UCI part of the multiplexed UCI;
determining, by the base station, a second coding rate for a second UCI part of the multiplexed UCI;
generating, by the base station, a physical uplink control channel (PUCCH)-Config message that indicates the first coding rate for the first UCI part and the second coding rate for the second UCI part; and
transmitting, by the base station, the PUCCH-Config message to a user equipment (UE) that is to utilize the first coding rate and the second coding rate to determine a PUCCH transmission power for the multiplexed UCI.

19. The method of claim 18, wherein the PUCCH-Config message comprises a high priority PUCCH-Config message.

20. The method of claim 18, further comprising processing the multiplexed UCI received from the UE in a PUCCH transmission, wherein the PUCCH transmission is transmitted at a PUCCH transmission power determined based on the first coding rate and the second coding rate.
